(19) United States
(12) Patent Application Publication
(10) Pub. No.: US 2021/0044856 A1
(43) Pub. Date: Feb. 11, 2021

(54) INFORMATION PROCESSING DEVICE, INFORMATION PROCESSING METHOD, AND RECORDING MEDIUM

(71) Applicant: SONY CORPORATION, TOKYO (JP)

(72) Inventors: RYUICHI SUZUKI, TOKYO (JP); KENTARO IDA, TOKYO (JP)

(21) Appl. No.: 16/982,461

(22) PCT Filed: Jan. 15, 2019
(86) PCT No.: PCT/JP2019/000813

§ 371 Date: Sep. 18, 2020

(30) Foreign Application Priority Data
Mar. 29, 2018 (JP) 2018-063946

(51) Int. Cl. H04N 21/436; H04N 21/431; H04N 21/442

(52) U.S. Cl. CPC H04N 21/436; H04N 21/44218; H04N 21/431

(57) ABSTRACT

[Problem] An information processing device, an information processing method, and a recording medium that are capable of changing output settings of a content adaptively to a change of a viewing environment of the content while the content is being output are provided. [Solution] An information processing device that includes an output control unit that changes, based on whether it is determined that a first viewing environment of a content in a first timing in which the content has been output and a second viewing environment of the content in a second timing that is later than the first timing are identical based on information of a user that has been viewing the content in the first timing, output settings of the content by an output unit after the second timing.

### FIELD

The present disclosure relates to an information processing device, an information processing method, and a recording medium.

### BACKGROUND

Various kinds of output devices that enable a user to change an output position of a content, such as a projector, have conventionally been developed.

For example, in Patent Literature 1 below, a technique in which distance information of plural points in a projection region or focus information is acquired, and a projection-enabled region within the projection region is analyzed based on the resultant of acquisition of these pieces of information is described.

### CITATION LIST

### Patent Literature

Patent Literature 1: JP-A-2015-145894

### SUMMARY

### Technical Problem

However, in the technique described in Patent Literature 1, appropriately changing output settings for a content adaptively to a change of viewing environment of the content during output of the content is not taken into consideration.

The present disclosure proposes a new and improved information processing device, an information processing method, and a recording medium that are capable of changing output settings for a content adaptively to a change of viewing environment of the content during output of the content.

### Solution to Problem

According to the present disclosure, an information processing device is provided that includes: an output control unit that changes, based on whether it is determined that a first viewing environment of a content in first timing in which the content has been output and a second viewing environment of the content in second timing that is later than the first timing are identical based on information of a user that has been viewing the content in the first timing, output settings of the content by an output unit after the second timing.

Moreover, according to the present disclosure, an information processing method is provided that includes: changing output settings of a content by an output unit after a second timing based on whether it is determined that a first viewing environment of the content in a first timing in which the content has been output and a second viewing environment of the content in a second timing that is later than the first timing are identical based on information of a user that has been viewing the content in the first timing, by a processor.

Moreover, according to the present disclosure, a computer-readable recording medium is provided that stores a program to make a computer function as an output control unit that changes, based on whether it is determined that a first viewing environment of a content in first timing in which the content has been output and a second viewing environment of the content in second timing that is later than the first timing are identical based on information of a user that has been viewing the content in the first timing, output settings of the content by an output unit after the second timing.

### Advantageous Effects of Invention

As explained above, according to the present disclosure, output settings for a content can be changed adaptively to a change of viewing environment of the content during output of the content. An effect described herein is not necessarily limited, but either of effects described in the present disclosure may be produced.

### BRIEF DESCRIPTION OF DRAWINGS

FIG. 1 is a diagram illustrating an example of a layout of a house 2 according to respective embodiments of the present disclosure.

FIG. 2 is a diagram schematically illustrating a state of an inside of a room 4 according to the respective embodiments of the present disclosure.

FIG. 3 is a block diagram illustrating an example of a schematic configuration of an information processing device 10 according to a first embodiment of the present disclosure.

FIG. 4 is a diagram illustrating an example of determination for a move of a user, for each combination of the rooms 4 before and after the move of the user, by a determining unit 106 according to the first embodiment.

FIG. 5 is a diagram illustrating an example of determination of change of posture of the user, for each of combinations of posture change by the determining unit 106 according to the first embodiment.

FIG. 6A is a diagram illustrating a user 6 viewing content 20 in the room 4 corresponding to a first viewing environment according to the first embodiment.

FIG. 6B is a diagram illustrating an example of a display mode change of the content 20 while the user 6 is temporarily out of the room 4 after the timing illustrated in FIG. 6A.

FIG. 7 is a flowchart illustrating an example of a general flow of processing according to the first embodiment.

FIG. 8 is a flowchart illustrating a flow of detailed processing of S109 illustrated in FIG. 7.

FIG. 9A is a diagram for explaining a problem of a second embodiment.

FIG. 9B is a diagram for explaining a problem of the second embodiment.

FIG. 9C is a diagram for explaining a problem of the second embodiment.

FIG. 10 is a diagram illustrating an example of a determination region 32 set on a projection surface 30 according to the second embodiment.

FIG. 11 is a diagram illustrating a determination example of whether a move of an object is a “temporary action” or a “continual action” by the determining unit 106 according to the second embodiment, for each attribute of the object.

FIG. 12 is a diagram illustrating a determination example of whether a reduction of visibility is a “temporary action” or a “continual action”, for each factor of reduction of the visibility by the determining unit 106 according to the second embodiment.

FIG. 13 is a flowchart illustrating a part of the flow of detailed processing of S109 according to the second embodiment.

FIG. 14 is a flowchart illustrating a part of the flow of detailed processing of S109 according to the second embodiment.

FIG. 15A is a diagram for explaining a change example of output settings for content after the second timing based on an instruction input by a user according to the second embodiment.

FIG. 15B is a diagram for explaining a change example of output settings for content after the second timing based on an instruction input by a user according to the second embodiment.

FIG. 15C is a diagram for explaining a change example of output settings for content after the second timing based on an instruction input by a user according to the second embodiment.

FIG. 16 is a diagram illustrating an example in which the content 20 is projected on the projection surface 30.

FIG. 17 is a diagram illustrating a display example of information indicating an output position after a change of the content 20 after timing indicated in FIG. 16.

FIG. 18 is a diagram illustrating another display example of information indicating the output position after the change of the content 20 after the timing indicated in FIG. 16.

FIG. 19 is a diagram illustrating a display example of a transition image before a final change of output settings for content according to a third embodiment.

FIG. 20 is a diagram illustrating another display example of a transition image before the final change of output settings for content according to the third embodiment.

FIG. 21 is a diagram illustrating another display example of a transition image before the final change of output settings for content according to the third embodiment.

FIG. 22 is a diagram illustrating another display example of a transition image before the final change of output settings for content according to the third embodiment.

FIG. 23 is a flowchart illustrating a part of a flow of processing according to the third embodiment.

FIG. 24 is a flowchart illustrating a part of the flow of processing according to the third embodiment.

FIG. 25 is a diagram illustrating an example of a hardware configuration of the information processing device 10 according to the respective embodiments of the present disclosure.

### DESCRIPTION OF EMBODIMENTS

Hereinafter, exemplary embodiments of the present disclosure will be explained in detail below with reference to the accompanying drawings. in the present application and the drawings, identical reference signs are assigned to components having substantially the same functional configurations, and duplicated explanation will be omitted.

Moreover, in the present application and the drawings, plural components having substantially the same functional configurations can be distinguished thereamong by adding different alphabets after the identical reference symbols. For example, plural components having substantially the same functional configurations are distinguished as an input unit 200a and an input unit 200b as necessary. When it is not particularly necessary to distinguish each among plural components having substantially the same functional configurations, only the identical reference symbol is assigned. For example, when it is not necessary to distinguish between the input unit 200a and the input unit 200b, it is simply referred to as input unit 200.

Furthermore, “embodiments to implement the invention” will be explained according to order of subjects given below.
1. Overview
2. First Embodiment
3. Second Embodiment
4. Third Embodiment
5. Hardware Configuration
6. Modification

### 1. Overview

The present disclosure can be implemented in various forms as explained in detail in “2. First Embodiment” to “4. Third Embodiment” as one example. First, an overview of the respective embodiments of the present disclosure will be explained.

### 1-1. System Configuration

In the respective embodiments, it is assumed that a system that is capable of outputting content at an arbitrary position in predetermined space (for example, a predetermined facility) is established. The predetermined facility may be, for example, the house 2 (living space), a building, an amusement park, a station, an airport, or the like. In the following, an example in which the predetermined facility is the house 2 will be mainly explained.

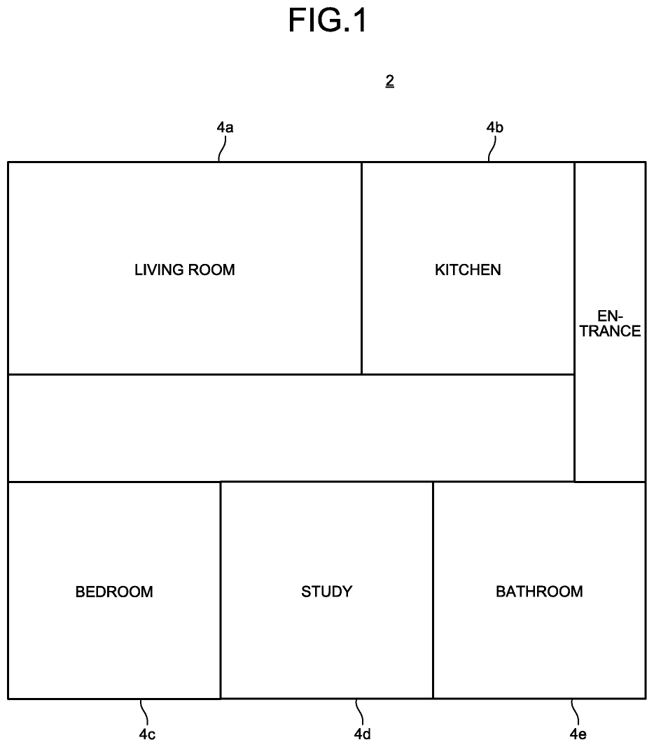

For example, as illustrated in FIG. 1, in the house 2, the plural rooms 4 are arranged. The rooms 4 are one example of a first place and a second place according to the present disclosure.

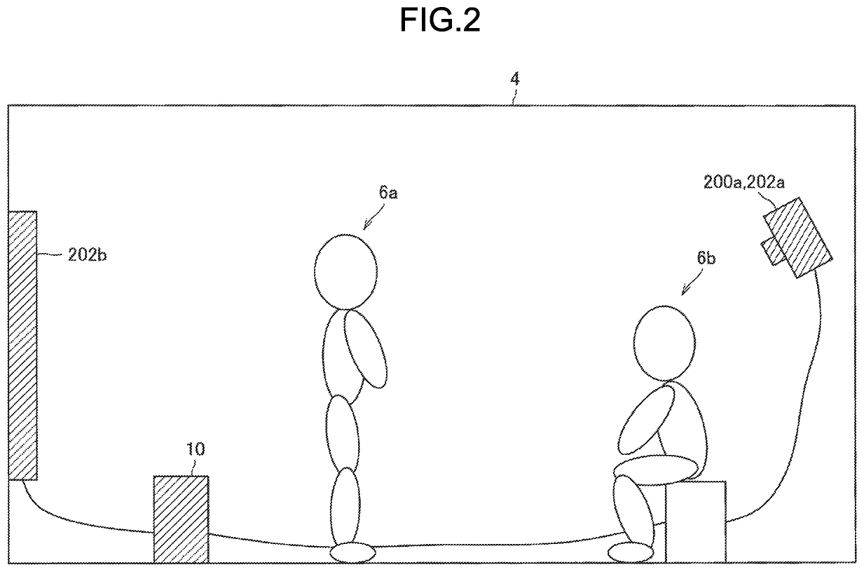

Moreover, as illustrated in FIG. 2, in the respective embodiments, a scene in which one or more users 6 are located in at least one of the rooms 4 is assumed. Furthermore, as illustrated in FIG. 2, in each of the rooms 4, at least one unit of the input unit 200 described later can be arranged. Moreover, in each of the rooms 4, at least one unit of output unit 202 described later may further be arranged.

### 1-1-1. Input Unit 200

The input unit 200 is one example of an acquiring unit according to the present disclosure. The input unit 200 may include, for example, an RGB camera, a distance sensor (for example, a two-dimensional time of flight (ToF) sensor, a stereo camera, or the like), a light detection and ranging (LIDAR), a thermosensor, and/or a sound input device (microphone, or the like). Moreover, the input unit 200 may include a predetermined input device (for example, a keyboard, a mouse, a joystick, a touch panel, or the like).

All of these sensors included in the input unit 200 may be arranged in an environment (specifically, each of the rooms 2). Alternatively, some of these sensors may be carried (for example, worn) by at least one user. For example, a user may carry a transmitter or an infrared-light irradiating device, or the user may put on a retroreflective material, or the like.

This input unit 200 inputs information related to a user or/and information related to an environment. The information related to a user can include a sensing result about, for example, a location, a posture, a sight, an eye direction, and/or a face orientation of the user. The information related to an environment can be defined for each of the rooms 4. The information related to an environment can include a sensing result about, for example, a shape of a surface to be projected (hereinafter, it can be referred to as projection surface) of a projection unit described later (one example of an output unit 202), asperities of a projection surface, a color of a projection surface, presence or absence of an obstacle or a shielding material in the room 4, luminance information of the room 4, and/or the like.

The information related to an environment may be acquired in advance by sensing by various kinds of sensors included in the input unit 200. In this case, the information related to an environment is not necessarily required to be acquired in real time.

### 1-1-2. Output Unit 202

The output unit 202 outputs various kinds of information (image and sound) in accordance with an output control of a control unit 108 described later. The output unit 202 can include a display unit. The display unit displays (projects, or the like) an image in accordance with a control of the output control unit 108.

This display unit includes, for example, a liquid crystal display (LCD), an organic light emitting diode (OLED), and the like), or a projector and the like. For example, the display unit may be a (driven) projecting unit (for example, a driven projector) that is configured to be able to change at least one of the position and the orientation in accordance with a control of the output control unit 108 described later. This driven projecting unit can be able to project an image at an arbitrary position in the house 2, for example, while changing its position inside the house 2. The driven projecting unit can include a driving motor.

Furthermore, the output unit 202 can include a sound output unit. The sound output unit includes, for example, a speaker, an earphone or a headphone, and the like. The sound output unit outputs sound (voice, music, and the like) in accordance with a control of the output control unit 108.

All of the output units 202 located in the house 2 may be fixed in the house 2, or at least one of the output unit 202 may be carried by a user. Examples of the output unit 202 of the latter case include, for example, a mobile phone, such as a smartphone, a tablet terminal, mobile music player, and a wearable device (for example, an eyewear (augmented reality (AR) glass, a head mounted display (HMD), and the like), a smartwatch, a headphone, an ear phone, or the like).

### 1-1-3. Information Processing Device 10

The information processing device 10 can be a device that is capable of controlling output of content by the output unit 202. For example, the information processing device 10 performs analysis of information (for example, a sensing result and the like) acquired by the input unit 200 and performs various kinds of processing (for example, determination of information to be output, selection of the output unit 202 to output the information from among the output units 202 in the house 2, determination of parameters of the relevant output unit 202, and the like) based on this analysis result. As one example, at the analysis of the information acquired by the input unit 200, the information processing device 10 may identify, for example, a three-dimensional position relationship between a projecting unit, such as a projector, (one example of the output unit 202) and a projection surface, and may analyze how a user can recognize an image projected on the projection surface based on the identified position relationship.

This information processing device 10 may be, for example, a server, a general-purpose personal computer (PC), a tablet terminal, a game console, a mobile phone such as a smartphone, a wearable device, such as a head mounted device (HMD) and a smartwatch, an in-car device (car navigation system and the like), or a robot (for example, a humanoid robot, a pet robot, a drone, and the like).

As illustrated in FIG. 2, the information processing device 10 may be arranged in one of the rooms 4. In this case, the information processing device 10 can be configured to be able to communicate with each of the input units 200 and each of the output units 202 by wired or wireless communication.

Alternatively, the information processing device 10 may be arranged outside the house 2. In this case, the information processing device 10 may be able to communicate with each of the input units 200 and each of the output units 202 in the house 2 through a predetermined communication network. The predetermined communication network may include, for example, a public line network, such as telephone line network and the Internet, various kinds of local area network (LAN) including Ethernet (registered trademark), a wide area network (WAN), and the like.

### 1-2. Summary of Problems

The overview of the respective embodiments has been described above. By using, for example, a driven projector, a method of changing a display position of an image to be projected according to a change of an environment or movement of a user can be considered (hereinafter, referred to as first method).

However, in the first method, because a system can respond to these changes, for example, each time the user makes a temporary movement, or an object temporarily picked up by the user is moved, user experience can be deteriorated. To solve this problem, a method in which detection time for a change of an environment or movement of a user is increased to slow down the responsivity (hereinafter, referred to as second method) can also be considered. However, in the second method, actions of the system also become slow as the responsivity is reduced.

Focusing on the circumstance described above, the information processing device 10 according to the respective embodiments has been created. Based on whether it has been determined that a first viewing environment of content in first timing in which the content are being output and a second viewing environment of the content in second timing that follows the first timing are identical based on predetermined criteria, the information processing device 10 according to the respective embodiments changes output settings for the content by the output unit 202 after the second timing. Therefore, for example, the output settings for content can be appropriately changed, adaptively to a change of an environment or movement of a user. As a result, deterioration of user experience can be prevented.

In the respective embodiments, a viewing environment can be an environment (or space) in which one or more users are viewing some kind of content. For example, the viewing environment of one kind of content can be an environment (or space) in which one or more users are viewing the content. In the following, the respective embodiments will be explained in detail sequentially.

### 2. First Embodiment

### 2-1. Configuration

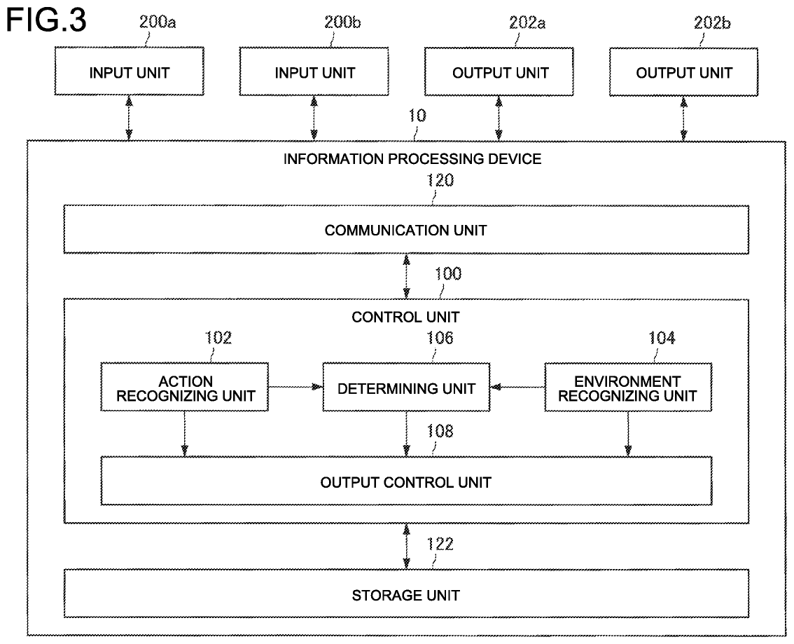

First, a first embodiment of the present disclosure will be explained. First, a configuration according to the first embodiment will be explained. FIG. 3 is a block diagram illustrating an example of a schematic configuration of the information processing device 10 according to the first embodiment. As illustrated in FIG. 3, the information processing device 10 includes a control unit 100, a communication unit 120, and a storage unit 122.

### 2-1-1. Control Unit 100

The control unit 100 can include, for example, a processing circuit, such as a central processing unit (CPU) 150 described later and a graphics processing unit (GPU). The control unit 100 can overall control operations of the information processing device 10. Moreover, as illustrated in FIG. 3, the control unit 100 includes an action recognizing unit 102, an environment recognizing unit 104, a determining unit 106, and the output control unit 108.

### 2-1-2. Action Recognizing Unit 102

The action recognizing unit 102 is one example of a first recognizing unit according to the present disclosure. The action recognizing unit 102 recognizes an action (for example, a change of location, a change of posture, and the like) of a user viewing content that is being output by the output unit 202 based on information acquired by one or more units of the input unit 200.

For example, the action recognizing unit 102 recognizes that the user has moved from a first place (for example, one room 4a) in which the user had been viewing the content to a second place (for example, another room 4b), based on information acquired by one or more units of the input unit 200. Moreover, the action recognizing unit 102 recognizes that the posture of the user has changed from a first posture to a second posture during the user is viewing the content in one place (for example, one room 4a), based on information acquired by one or more units of the input unit 200.

### 2-1-3. Environment Recognizing Unit 104

The environment recognizing unit 104 is one example of a second recognizing unit according to the present disclosure. The environment recognizing unit 104 recognizes a change in state of a place (for example, the room 4) in which the user viewing the content that is being output by the output unit 202 is located. For example, the environment recognizing unit 104 recognizes a change in an incident amount of sunlight to the room 4, or a change in an illumination degree of one or more lights in the room 4 (for example, a change in the number of lights being ON), based on information acquired by one or more units of the input unit 200.

### 2-1-4. Determining Unit 106

The determining unit 106 determines whether the first viewing environment and a second viewing environment are identical based on predetermined criteria. The predetermined criteria can include information about a user that has been viewing the content in timing (first timing) corresponding to the first viewing environment. As one example, the information about the user can include a recognition result of an action of the user obtained by the action recognizing unit 102 in a period between the first timing and timing corresponding to the second viewing environment (second timing). For example, the determining unit 106 first determines whether the action recognized as performed by the user between the first timing and the second timing is a “continual action” or a “temporary action”. As one example, when an action causing a change in location of the user and/or a change in posture is performed between the first timing and the second timing, the determining unit 106 determines whether the action is a “continual action” or a “temporary action”. For example, the determining unit 106 may determine the action of the user is a “continual action” or a “temporary action” based on a combination of a degree of the change in location of the user and a degree of the change in posture of the user. Alternatively, regarding whether the action of the user is a “continual action” or a “temporary action”, the determining unit 106 may perform determination based on a degree of the change in location of the user, and determination based on a degree of the change in posture of the user, sequentially.

Having determined that the action of the user is a “temporary action”, the determining unit 106 determines that the first viewing environment and the second viewing environment are identical. Moreover, having determined that the action of the user is a “continual action”, the determining unit 106 determines that the first viewing environment and the second viewing environment are not identical.

The “temporary action” can be such an action that the location and/or posture of the user in the first timing once changes and returns, by the time of the second timing, back to the location and/or posture of the user in the first timing. That is, after the “temporary action”, the user can continue viewing the content in the location and/or posture similar to those of the first timing. Moreover, the “continual action” can be an action that is determined that the location and/or posture of the user in the first timing changes, and does not return to the location and/or posture of the first timing by the time of the second timing.

### 2-1-4-1. Predetermined Criteria 1: Change of Location

In the following, the “predetermined criteria” described above will be more specifically explained. For example, the predetermined criteria includes information that indicates whether the action recognizing unit 102 has recognized that the user has moved from the first place (for example, one room 4a) corresponding to the first viewing environment to the second place (for example, another room 4b) in a period between the first timing and the second timing, and a relationship between the first place and the second place. For example, when it is recognized that the user has moved from one room 4a to another room 4b in a period between the firs timing and the second timing, the determining unit 106 first determines whether the move is the “continual action” or the “temporary action” based on the information indicating relationship between the first place and the second place. The determining unit 106 then determines whether the first viewing environment and the second viewing environment are identical based on the determination result. The information indicating a relationship between the first place and the second place can be stored in the storage unit 122 described later in advance.

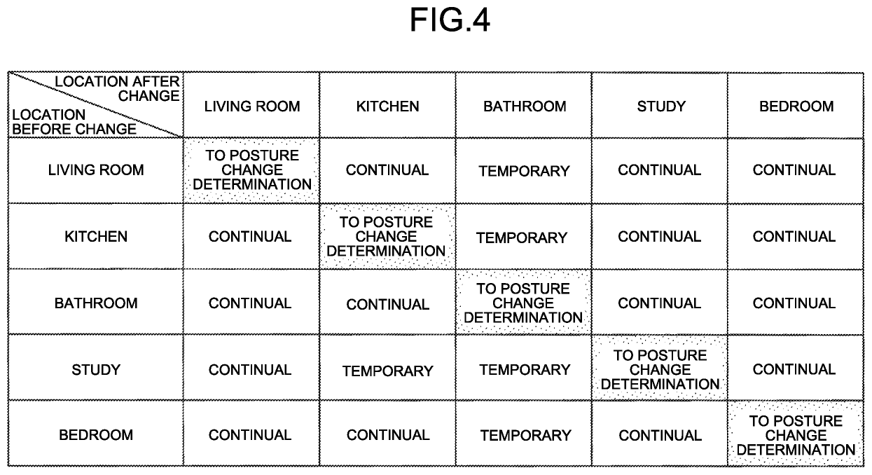

More details of what is described above will herein be explained with reference to FIG. 4. FIG. 4 is a diagram illustrating an example of determination whether a move of the user is the “continual action” or the “temporary action” for each combination of the room 4a before the move and the room 4b after the move of the user. In a table in FIG. 4, the column shows kinds of the room 4a before a move, and the row shows kinds of the room 4b after the move. In the example in FIG. 4, when the room 4a before a move of a relevant user is “living room”, and the room 4b after the move of the user is “kitchen”, the determining unit 106 determines that the move of the user is the “continual action”. That is, in this case, the determining unit 106 determines that the first viewing environment and the second viewing environment are not identical.

Moreover, when the room 4a before a move of a relevant user is “living room”, and the room 4b after the move of the user is “bathroom”, the determining unit 106 determines that the move of the user is the “temporary action”. In this case, for example, when the user continues to be located in “bathroom” after the move until the second timing, the determining unit 106 determines that the first viewing environment and the second viewing environment are identical.

The table (determination table) in FIG. 4 may be created by a method as follows. For example, a template is created based on human characteristics in a predetermined environment that has already been identified, and the determination table can be automatically or manually created according to the template. Moreover, each of determinations (configuration values) in the determination table may be automatically corrected according to a situation of a user each time. Furthermore, each of determinations in the determination table may be changed by a user explicitly (manually).

### Modification

It can be assumed that the user moves among the three or more rooms 4 in a period between the first timing and the second timing. In such a case, the determining unit 106 may determine a relationship between the room 4a before a move and the room 4b after the move sequentially, for example, using the table in FIG. 4, and may determine that the entire move of the user is the “continual action” when it is determined to be reached the “continual” room 4 at least once between the first room 4a and the final room 4b. For example, in the example illustrated in FIG. 4, when the user moves as “living room”→“bathroom”→“kitchen”→“living room”, the determining unit 106 may determine that a move from “bathroom” to “kitchen” is the “continual action” by using the table in FIG. 4, and may determine the entire move of the user as the “continual action”.

### 2-1-4-2. Predetermined Criteria 2: Change of Posture

Furthermore, the predetermined criteria can further include whether the action recognizing unit 102 has recognized a change of a posture of the user from the first posture in the first timing to the second posture in the same place (for example, the same room 4) in a period between the first timing and the second timing, and information indicating a relationship between the first posture and the second posture. For example, when it is recognized that the posture of the user has changed from the first posture to the second posture between the first timing and the second timing in one room 4, the determining unit 106 first determines whether the change of the posture is the “continual action” or the “temporary action” based on the information indicating a relationship between the first posture and the second posture. Based on the determination result, the determining unit 106 determines whether the first viewing environment and the second viewing environment are identical. The first posture and the second posture may be, for example, either a seated position, a lying position, or a standing position. Moreover, the information indicating a relationship between the first posture and the second posture may be stored in advance in the storage unit 122 described later.

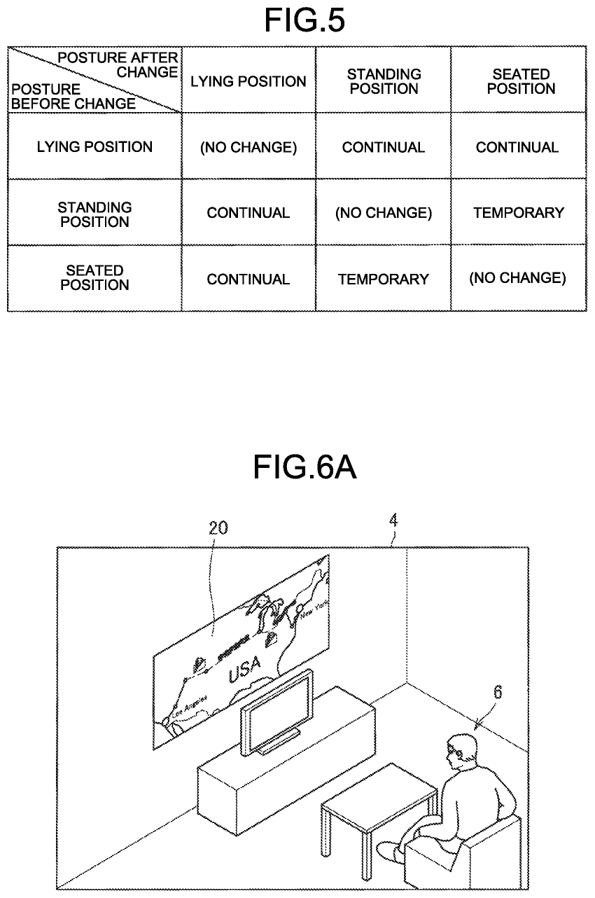

More details of what is described above will herein be explained with reference to FIG. 5. FIG. 5 is a diagram illustrating an example of determination for an action of a user corresponding to each combination is whether the “continual action” or the “temporary action” for each of combinations of the first posture (in other words, posture before a change) and the second posture (in other words, posture after the change). In a table in FIG. 5, the column shows kinds of the first posture, and the row shows kinds of the second posture. In the example in FIG. 5, when the first posture of the user is “standing position”, and the second posture of the user is “lying position”, the determining unit 106 determines that the action (change of posture) of the user is the “continual action”. That is, in this case, the determining unit 106 determines that the first viewing environment and the second viewing environment are not identical.

Moreover, when the first posture of the user is “standing position”, and the second posture of the user is “seated position”, the determining unit 106 determines the action of the user as the “temporary action”. In this case, for example, when the posture of the user continues to be in “seated position” until the second timing after the action, the determining unit 106 determines that the first viewing environment and the second viewing environment are identical.

### Modification

As a modification, the determining unit 106 may vary a determination result whether an action corresponding to a combination is the “continual action” or the “temporary action”, even if the combination of the first posture and the second posture is identical, according to a kind of the room 4 in which the user is located. For example, while the user is located in “living room”, when it is recognized that the posture of the user has changed from “standing position” to “seated position”, the determining unit 106 may determine that the change of posture is the “continual action” (unlike the table in FIG. 5). On the other hand, while the user is located in “living room”, when the posture of the user has changed from “seated position” to “standing position”, the determining unit 106 may determine that the change of posture is the “temporary action” (as indicated in the table in FIG. 5).

### 2-1-5. Output Control Unit 108

The output control unit 108 controls output of information (content and the like) with respect to one or more units of the output unit 202. For example, the output control unit 108 first changes output settings of the content by at least one unit of the output unit 202 after the second timing described above, based on a determination result by the determining unit 106. The output control unit 108 causes at least one unit of the output unit 202 to output the content with the output settings after the change. The output settings of the content may include at least one of an output position of the content in the house 2, a display size of the content, a brightness of the content, and a contrast of the content. Moreover, the output settings may include identification information of the output unit 202 from which the content is output out of all of the output units 202 in the house 2.

### 2-1-5-1. Change of Output Settings

In the following, a change of the output settings for the content by the output control unit 108 will be more specifically explained. For example, when the determining unit 106 determines that the first viewing environment and the second viewing environment are not identical, the output control unit 108 may change the output settings for the content after the second timing, according to the second viewing environment. As one example, when it is determined as such, the output control unit 108 may determine an output position of the content after the second timing to a predetermined position in the second place (for example, the room 4 corresponding to the second viewing environment).

Moreover, when it is determined as such, and when the output unit 202 that outputs the content is the driven projector, the output control unit 108 may control the driven projector to successively change a projection position of the content from a projection position of the content in the first place in the first timing to the predetermined position in the second place. For example, in this case, the output control unit 108 may control the driven projector to successively change the projection position of the content from the projection position of the content in the first place to the predetermined position in the second place, so as to guide eyes of the user by using a detection result of an eye direction of the user that is detected in real time. By these control examples, the user can recognize that the projection position of the content will be changed to another position easily and, therefore, it is possible to avoid the user from losing sight of the content.

Furthermore, when the determining unit 106 determined that the first viewing environment and the second viewing environment are identical, the output control unit 108 do not need to change the output settings for the content.

### Modification

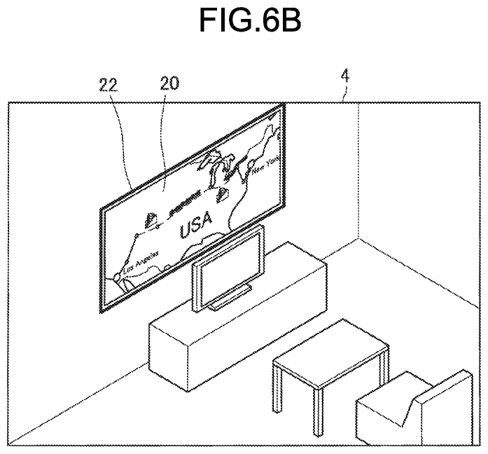

As a modification, when it is determined that the first viewing environment and the second viewing environment are not identical, and when the determining unit 106 determines that an action made by a user is the “temporary action”, the output control unit 108 may change a display mode of content being output in the first viewing environment. An example of this change will be explained in more detail by referring to FIG. 6A and FIG. 6B. FIG. 6A is a diagram illustrating the user 6 viewing the content 20 in the room 4a (for example, “living room”) corresponding to the first viewing environment in the first timing. In the example illustrated in FIG. 6A, the content 20 is projected on a wall near a television receiver in the room 4a by the projecting unit 202 (the output unit 202). Suppose that the user 6 has moved from the room 4a to the other room 4b in a period between the first timing and the second timing, and that the determining unit 106 has determined that the move is the “temporary action”. In this case, for example, as illustrated in FIG. 6B, the output control unit 108 may change the display mode of the content 20 such that a frame 22 around the content 20 is displayed in an emphasized manner during the move (for example, by changing a display color of the frame 22, by enlarging a display size of the frame 22, or the like).

### 2-1-5-2. Output of Content After Change

Moreover, when the output settings for the content are changed, the output control unit 108 causes at least one of the output units 202 to output the content with the output settings after the change. For example, in this case, the output control unit 108 successively change the output settings for the content from the output settings before the change to the output settings after the change. As one example, the output control unit 108 may change a transition speed to the output settings after the change (for example, the output position after the change, or the like) from the output settings before the change (for example, the output position before the change, or the like), according to a change of location or a change of posture of the user in the second timing (or within a predetermined period before and after that). For example, when a distance between the output position before the change and the output position after the change is short, the output control unit 108 may control the output unit 202 to output the content such that the content slides from the output position before change to the output position after the change. Moreover, when the distance between the output position before the change to the output position after the change is long, or when the change in location of the user is large, the output control unit 108 may control the output unit 202 to change the output position of the content successively by using an expression of a fade effect, instead of sliding the content.

### 2-1-6. Communication Unit 120

The communication unit 120 can include a communication device 166 described later. The communication unit 120 performs transmission and reception of information by wired communication and/or wireless communication with the respective input units and the respective output units 202. For example, the communication unit 120 can receive information that is acquired by the respective input units 200 from the respective input units 200. Moreover, the communication unit 120 can transmit control information to output various kinds of information to one or more units of the output units 202 in accordance with control of the output control unit 108.

### 2-1-7. Storage Unit 122

The storage unit 122 can include a storage device 164 described later. The storage unit 122 stores various kind of data and various kinds of software. For example, the storage unit 122 can store information indicating a relationship between the first place and the second place, information indicating a relationship between the first posture and the second posture described before, and the like.

### 2-2. Flow of Processing

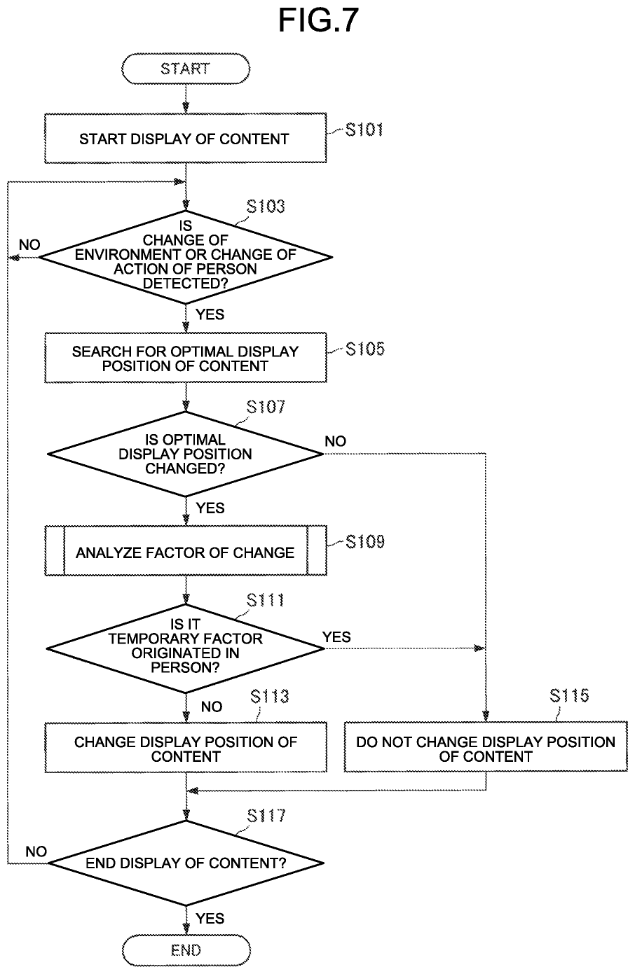

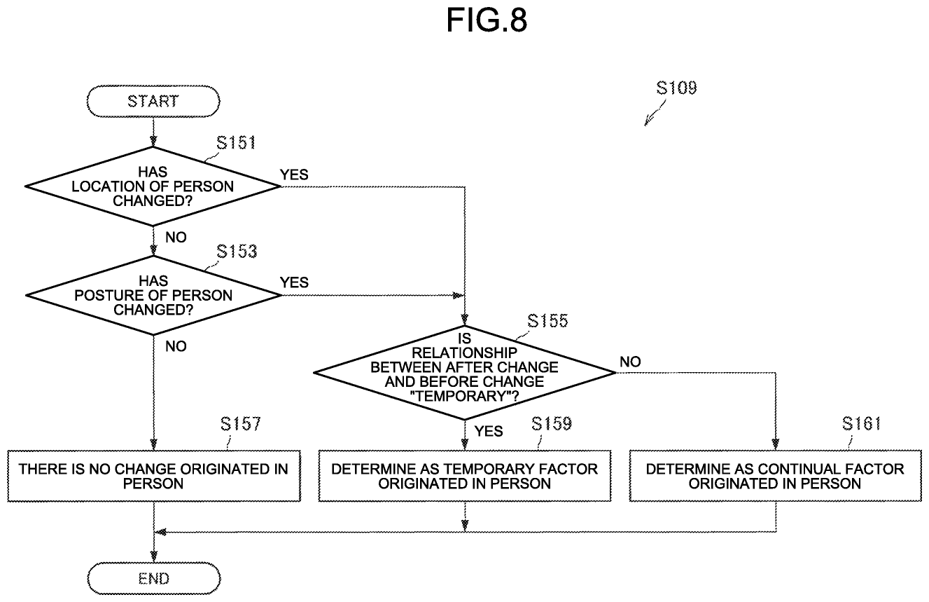

The configuration according to the first embodiment has been explained above. Next, a flow of processing according to the first embodiment will be explained, referring to FIG. 7 and FIG. 8.

### 2-2-1. General Flow

FIG. 7 is a flowchart illustrating an example of a general flow of processing according to the first embodiment. As illustrated in FIG. 7, first, the output control unit 108 causes the output unit 202 to start projection of content to be output in the room 4 in which the user is located (S101). At this time, one or more units of the input unit 200 in the house 2 may be configured to acquire, at all times, information relating to the respective users in the house 2, and information relating to a state of the respective rooms 4 in the house 2 (that is, information relating to an environment inside the house 2).

Thereafter, the environment recognizing unit 104 recognizes whether a state of the room 4 has changed, for example, based on information sensed by the respective input units 200 in the room 4. Similarly, the action recognizing unit 102 recognizes whether the user has started an action causing a change of location or posture, for example, based on information sensed by the respective input units 200 in the room 4 (S103).

When it is determined that the state of the room 4 has not changed and the user has not made an action causing a change of location or posture (step S103: NO), the control unit 100 repeats the processing at S103 again, for example, after a predetermined time has passed.

On the other hand, when it is determined that the state of the room 4 has changed, or when it is determined that the user has started an action causing a change of location or posture (S103: YES), the output control unit 108 searches for an optimal display position of the content of a current time, for example, based on a recognition result by the environment recognizing unit 104 and a recognition result of the action recognizing unit 102 (S105).

When a display positioned searched at S105 is same as a current display position of the content (S107: NO), the output control unit 108 performs processing of S115 described later.

On the other hand, when the display position searched at S105 is different from the current display position of the content (S107: NO), the determining unit 106 performs “analysis of a change factor” described later (S109). The factor determined at S109 is not a “temporary factor originated in person” (S111: NO), the output control unit 108 changes the latest display position of the content to the display position searched at S105 (S113). The output control unit 108 then performs processing of S117 described later.

“Temporary” here can mean that a duration of a location in which the user is positioned or a posture of the user is within upper limit time that allows content viewing (without any trouble). The length of the upper limit time may be predetermined length of time (5 minutes or the like). Alternatively, the length of the upper limit time may be changed depending on the content. For example, when the content is a long content (for example, a movie or the like), the length of the upper limit time may be set to be longer than usual. Moreover, when the content is a content that require real-timeness (for example, a live broadcast, a television program, and the like), the length of the upper limit time may be set to be shorter than usual, for example to several seconds. Alternatively, the length of the upper limit time may be set to most suitable time according to the user.

On the other hand, when the factor determined at S109 is a “temporary factor originated in person” (S111: YES), the output control unit 108 determines not to change the display position of the content (S115). Thereafter, when condition for ending the display of the content are satisfied (for example, when there is a predetermined input by the user) (S117: YES), the output control unit 108 causes the output unit 202 to end the output of the content. Thus, the flow of processing is finished.

On the other hand, when the condition for ending the display of the content are not satisfied (S117: NO), the control unit 100 repeats again the processing at S103 and later.

### 2-2-1-1. Modification

The general flow of the processing according to the first embodiment is not limited to the example described above. For example, the processing at S105 is not limited to the example in which it is performed when the condition at S103 are satisfied (that is, when a change of an environment in the room 4 or a change of an action of the user is recognized). As a modification, the processing at S105 may be performed when another condition (for example, turning on a power of a predetermined electronic device (for example, a television receiver, and the like) by the user, or the user entering the predetermined room 4, and the like) are satisfied, instead of the condition at S103.

### 2-2-2. Analysis of Change Factor of Display Position of Content

FIG. 8 is a flowchart illustrating one example of a flow of detailed processing at S109 described above. As illustrated in FIG. 8, first, the determining unit 106 determines whether it is recognized at latest S103 that the user has moved from the room 4a in which the user has been viewing the content to the other room 4b (S151). When it is recognized that the user has moved to the other room 4b (S151: YES), the determining unit 106 determines whether the move is the “temporary action” based on a relationship between the room 4a before the move and the room 4b after the room (S155). When it is determined that the move is the “temporary action” (S155: YES), the determining unit 106 performs processing of S159 described later. On the other hand, when it is determined that the move is not the “temporary action” (that is, the “continual action”) (S155: NO), the determining unit 106 performs processing of S161 described later.

On the other hand, when it is recognized that the user has not moved to the other room 4b (that is, has been staying in the same room 4a) (S151: NO), the determining unit 106 determines whether a change of posture of the user has been recognized at latest S103 (S153). When it is recognized that the posture of the user has not been changed (S153: NO), the determining unit 106 determines that the factor of change of the optimal display position of the content determined at S107 is not a factor originated in person (S157).

On the other hand, when it is recognized that the posture of the user has changed to another posture (S153: YES), the determining unit 106 determines whether the action (change of posture) is the “temporary action” based on the relationship between a kind of posture before the change and a kind of posture after the change (S155). When it is determined that the action is the “temporary action” (S155: YES), the determining unit 106 determines that the factor of change of the optimal display position of the content determined at S107 is the “temporary factor originated in person” (S159).

On the other hand, when it is determined that the action is not the “temporary action” (that is, the “continual action”) (S155: YES), the determining unit 106 determines that the factor of change of the optimal display position of the content determined at S107 is the “continual factor originated in person” (S161).

### 2-3. Effect

As explained above, the information processing device 10 according to the first embodiment changes output settings of a content by the output unit 202 after the second timing, based on whether it has been determined that the first viewing environment of the content in the first timing in which the content are output and the second environment of the content in the second timing, which is a later timing than the first timing, are identical based on predetermined criteria. Therefore, for example, output settings of a content can be changed adaptively to a change of environment or a move of a user.

For example, when an action of a user is determined as the “continual action”, the information processing device 10 changes the output settings of the content according to the second environment. Moreover, when it is determined that an action of a user is the “temporary action”, the information processing device 10 does not change the output settings of the content. Therefore, even if the user makes a “temporary action”, for example, a display position of the content are not to be change and, therefore, deterioration of the user experience can be avoided.

### 2-4. Modification

### 2-4-1. First Modification

The first embodiment is not limited to the example described above. For example, a determination example of an action of a user by the determining unit 106 is not limited to the example described above. For example, when it is recognized that a user has started moving, and that all of powers in the room 4 in which the user has been located are turned OFF, the determining unit 106 may determine that the move of the user as the “continual action”.

Alternatively, when equipment that has been being used by a user in the first place until shortly before is switched to OFF, or when a shutdown operation of the equipment is performed, the determining unit 106 may determine that the move of the user to be performed thereafter as the “continual action”.

Alternatively, when an explicit action indicating that a change of an output position of content that is being output in the first place is not desired (for example, putting some kinds of object on the content, or the like) is recognized, the determining unit 106 may determine, irrespective of another action of the user during a period between the first timing and the second timing (for example, moving to the other room 4a, and then returning back to the original room 4b, and the like), that the action of the user performed in this period as the “temporary action”.

### 2-4-2. Second Modification

As another modification, even when the determining unit 106 determines that an action of the user is the “temporary action”, the output control unit 108 may change the output settings (output position, or the like) of content being viewed by the user. For example, when it is assumed that the user or one or more objects in the house 2 can be endangered because fire (gas stove and the like) or water is being used, even if the determining unit 106 determines an action of the user performed during the use of these as the “temporary action”, the output control unit 108 may change the output settings of the content being viewed by the user to other output settings forcibly.

### 2-4-3. Third Modification

As another modification, when plural users are present in the house 2, the output control unit 108 may determine output settings of content according to which user out of the plural users the content to be output is shown. For example, in a case in which a movie is projected in a living room, the output control unit 108 may cause the output unit 202 to project the movie in a direction toward which more users (majority of users) face. In this case, the output control unit 108 may display the movie further on a display device for each user (for example, a display device carried by each user) for respective users other than the majority users in the living room, simultaneously to projection by the output unit 202.

### 2-4-4. Fourth Modification

As another modification, when a first exception condition is satisfied, even when the determining unit 106 determines that the first environment described above and the second environment described above are not identical, the output control unit 108 is enable to avoid changing the output settings of the content after the second timing (that is, output of the content are continued with the original output settings). The first exemption condition may be a case in which a recognition accuracy of the action recognizing unit 102 or the environment recognizing unit 104 is equal to or lower than a predetermined threshold (for example, when the number of sensors arranged in the room 4 in which the content are being output is small, or the like). Alternatively, the first exemption condition may be a case in which the number of users in the house 2 is too large for the number of the output units 202 present in the house 2.

### 2-4-5. Fifth Modification

As another modification, when the content include an image, and a second exemption condition is satisfied, the output control unit 108 is enabled to exclude all or a part of the image from a content to be output by the output unit 202, and to cause the same unit or another unit of the output unit 202 to output a sound (for example text to speech (TTS) or the like) to inform about a content of the excluded image. For example, when the determining unit 106 determines a move of the user as the “temporary action”, the output control unit 108 may cause a sound output unit arranged near the user, or a sound output unit carried by the user to output a sound to inform about the content of the image (for example, a relay broadcast of a sport, or the like) during the move of the user.

Alternatively, the second exemption condition can include a case in which the projecting unit (one example of the output unit 202) that outputs the image is disabled to project at least a part of the image to an output position after the change for the image determined by the output control unit 108. In this case, the output control unit 108 may cause the output unit 202 capable of outputting a sound to output a sound (for example, TTS or the like) to inform about a content of image in a projection-disabled region out of the entire image.

Alternatively, the second exemption condition can include a case in which the size of a projection surface (or a display surface) including an output position after the change for the image determined by the output control unit 108 is smaller than a predetermined threshold. In this case, the output control unit 108 may cause the output unit 202 that is capable of outputting a sound to output a sound to inform about a content of the image (for example, sentences included in the image, or the like).

### 3. Second Embodiment

### 3-1. Background

The first embodiment has been explained above. Next, a second embodiment according to the present disclosure will be explained. First, a background that has led to creation of the second embodiment will be explained. For example, in an existing technique, even when a location or a posture itself of a user does not change, a change of a display position of content being displayed can occur according to a change of a position of an object that is being used by the user.

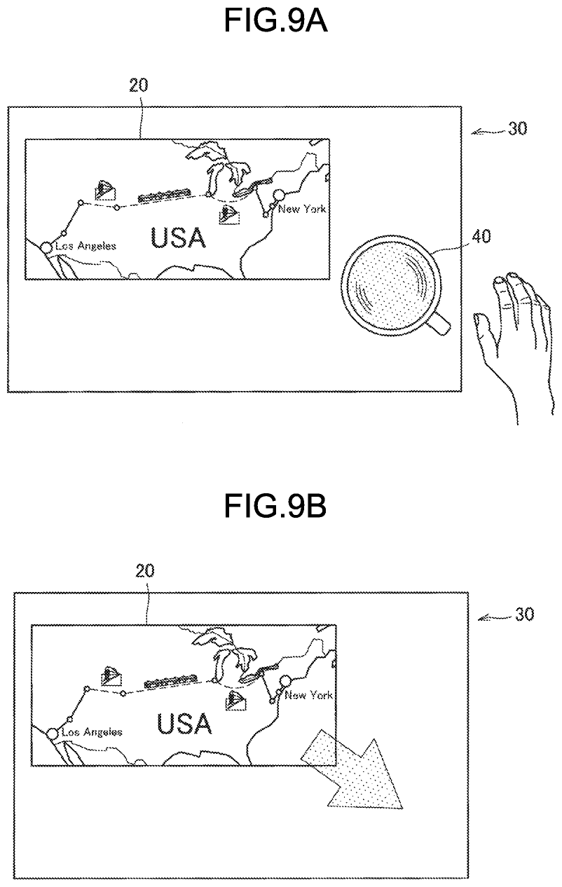

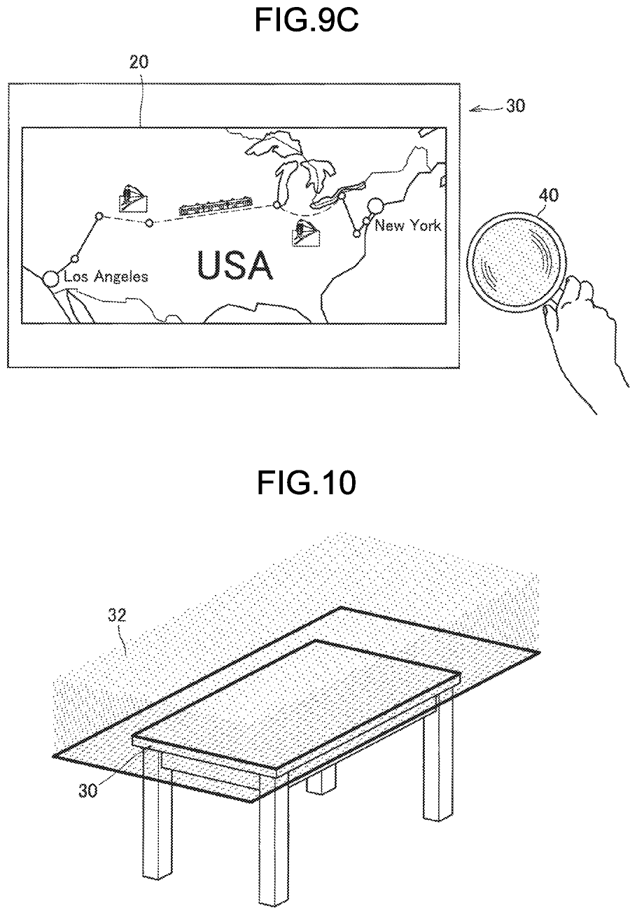

What is described above will be explained in more detail, referring to FIG. 9A to FIG. 9C. For example, as illustrated in FIG. 9A, suppose that an obstacle 40 (coffee cup 40 in the example illustrated in FIG. 9A) is placed on a projection surface 30 of a table. In this case, as illustrated in FIG. 9A, the content 20 can be projected on the projection surface 30 such that the content 20 does not overlap the obstacle 40.

Thereafter, when the user moves the obstacle 40, for example as indicated by an arrow in FIG. 9B, the information processing device 10 can enlarge a projection size of the content 20 being projected on the projection surface under the condition that the content 20 and the obstacle 40 do not overlap each other.

Thereafter, for example, as illustrated in FIG. 9C, suppose that the user intends to move the obstacle 40 again into a projection region of the content 20 currently being projected. In this case, the information processing device 10 can change the projection size of the content 20 being projected again according to a position to which the obstacle 40 is returned. However, by this method, the projection size of the content 20 is to be changed each time the user moves the obstacle 40 and, therefore, the behavior can be unstable, and the visibility can be reduced also.

A method in which the projection size of the content 20 is not changed even when the user moves the obstacle 40 is also considered. However, because the content 20 can be projected on the obstacle 40 by this method, the visibility of the content 20 can be reduced. Particularly, an object such as a coffee cup can be changed its position frequently by the user, the problem described above can occur frequently.

As described later, according to the second embodiment, output settings of content after the second timing can be appropriately changed, adaptively to a move of an object by a user or a change of a state of the first place (change of environment) in a period between the first timing and the second timing.

### 3-2. Configuration

Next, a configuration according to the second embodiment will be explained. respective components included in the information processing device 10 according to the second embodiment are similar to the example illustrated in FIG. 3. In the following, only components having functions different from the first embodiment will be explained, and explanation of the same component will be omitted.

### 3-2-1. Determining Unit 106

The determining unit 106 according to the second embodiment determines whether the first viewing environment and the second viewing environment are identical based on predetermined criteria (similarly to the first embodiment).

### 3-2-1-1. Predetermined Criteria 1: Variation of Position of Each Object

The predetermined criteria according to the second embodiment includes a detection result of whether at least one object in the first place corresponding to the first viewing environment is moved out of a predetermined region corresponding to the object by a user in a period between the first timing and the second timing described above. For example, when it is detected that at least one object positioned on a specific projection surface (for example, a projection surface on which the content are being projected) in the first place is moved by a user in a period between the first timing and the second timing, the determining unit 106 first determines whether an action of the user is the “continual action” or the “temporary action” based on whether the object is moved out of the predetermined region corresponding to the object. When determining that the action is the “temporary action”, the determining unit 106 determines that the first viewing environment and the second viewing environment are identical. Moreover, when determining that the action is the “continual action”, the determining unit 106 determines that the first viewing environment and the second viewing environment are not identical.

What is described above will be explained in more detail, referring to FIG. 10. In the example illustrated in FIG. 10, a top surface 30 of a table is determined as a projection surface of the content. Furthermore, as illustrated in FIG. 10, boundary surfaces are respectively set at positions apart from the top surface 30 by predetermined distances in three directions of depth, width, and height, and space sounded by these boundary surfaces can be determined as determination region 32. In this case, when it is recognized that the user has moved at least one object positioned on the top surface 30, out of the determination region 32, the determining unit 106 determines that the action of the user is the “continual action”. That is, in this case, the determining unit 106 determines that the first viewing environment and the second viewing environment are not identical.

Moreover, when it is recognized that the user has moved at least one object positioned on the top surface 30 within the determination region 32, the determining unit 106 determines the action of the user as the “temporary action”. That is, in this case, the determining unit 106 determines that the first viewing environment and the second viewing environment are identical.

### 3-2-1-2. Predetermined Criteria 2: Change of Position of Predetermined Object

Moreover, in the second embodiment, the predetermined criteria described above may further include a detection result of whether an object having a predetermined attribute in the first place is moved by a user in a period between the first timing and the second timing. For example, when it is detected that one object positioned on a specific projection surface in the first place is moved by a user in a period between the first timing and the second timing, the determining unit 106 first determines whether an action of the user is the “continual action” or the “temporary action” based on whether the object is an object having a predetermined attribute.

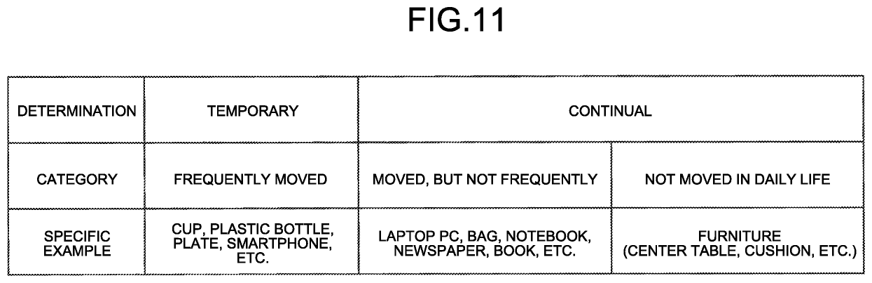

What is described above will be explained in more detail, referring to FIG. 11. FIG. 11 is a diagram illustrating a determination example of whether a move of the object is the “temporary action” or the “continual action” by the determining unit 106, for each attribute of the object. As illustrated in FIG. 11, when an object moved by the user is, for example, an object, frequency of move of which in daily life is equal to or higher than a threshold, the determining unit 106 determines that the move by the user is the “temporary action”. That is, in this case, the determining unit 106 determines that the first viewing environment and the second viewing environment are identical. As illustrated in FIG. 11, specific examples of the “object, frequency of move of which is equal to or higher than the predetermined threshold” include food, drink, a tableware (plate and the like), a cup, a plastic bottle, a smartphone, and the like.

Moreover, as illustrated in FIG. 11, when an object moved by a user is, for example, an object, frequency of move of which in daily life is lower than the predetermined threshold, or is an object that is basically not moved in daily life, the determining unit 106 determines that an action of the user is the “continual action”. That is, in this case, the determining unit 106 determines that the first viewing environment and the second viewing environment are not identical. As illustrated in FIG. 11, specific examples of the “object, frequency of move of which is lower than the predetermined threshold” include a laptop PC, a back, a notebook, a newspaper, a book, and the like. Moreover, specific examples of the “object that is basically not moved in daily life” include furniture (for example, a low table, a cushion, and the like), and the like.

### First Modification

When a projection size of content is larger by a certain amount relative to a size of an object (for example, when the size of an object is significantly small, and the like), even if a position of the object has changed, it is assumed that an influence to viewing the content is small. Therefore, in such a case, the determining unit 106 may exempt the object from determination.

### Second Modification

Moreover, generally, as for objects such as writing tools, a length of use time of the object by a user can vary depending on its kind. Therefore, as another modification, when a length of use time these objects by the user sensed by one or more units of the input units 200 is equal to or longer than a predetermined threshold, the determining unit 106 may determine a use of the object as the “continual action”.

### 3-2-1-3. Predetermined Criteria 3: Degree of Change of Environment

Moreover, in the second embodiment, the predetermined criteria described above may further include a degree of change of a state of the first place described above recognized by the environment recognizing unit 104, in a period between the first timing and the second timing. As described above, examples of kinds of change of the state include a change in an incident amount of sunlight in the place (the room 4 or the like), a change in an illumination degree of one or more lights in the place, or the like.

For example, the determining unit 106 first determines whether the change of the state (change of an environment) is a “continual change” or a “temporary change” based on whether it has been recognized that the state of the first place has changed by an amount equal to or larger than a predetermined threshold from the state in the first place in the first timing, in a period between the first timing and the second timing. When it is recognized that the change of the state is the “temporary change”, the determining unit 106 determines that the first viewing environment and the second viewing environment are identical. Furthermore, it is recognized that the change of the state is the “continual change”, the determining unit 106 determines that the first viewing environment and the second viewing environment are not identical.

AS one example, suppose that the visibility is reduced by some kinds of change of an environment in the first place in a period between the first timing and the second timing. In this case, the determining unit 106 first identifies a factor of reduction of the visibility based on a sensing result by one or more units of the input units 200. The determining unit 106 then determines whether the reduction of the visibility is the “temporary change” or the “continual change” according to an identified type of the factor.

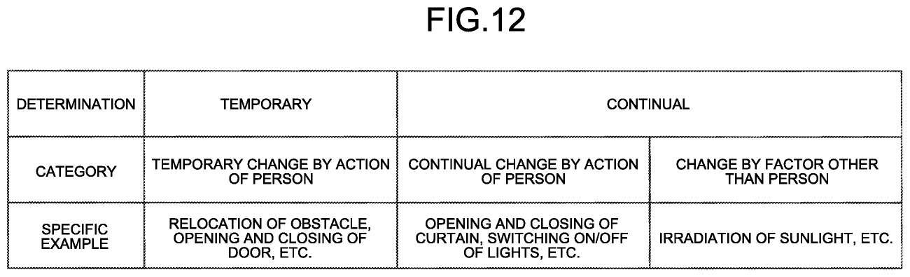

What is described above will be explained in more detail, referring to FIG. 12. FIG. 12 is a diagram illustrating a determination example of whether a reduction of visibility is the “temporary change” or the “continual change” when the visibility is reduced due to a change of an environment, for each factor of reduction of the visibility. As illustrated in FIG. 12, when the reduction of the visibility is determined as a “temporary change by an action of a person”, the determining unit 106 determines that the reduction of the visibility as the “temporary change”. In other words, in this case, the determining unit 106 determines that the first viewing environment and the second viewing environment are identical. As illustrated in FIG. 12, specific examples of the “temporary change by an action of a person” include relocation of an obstacle, opening and closing of a door (for example, a door of a living room, or the like), and the like.

Moreover, as illustrated in FIG. 12, when the reduction of the visibility is determined as a “continual change by an action of a person” or a “change by a factor other than a person”, the determining unit 106 determines that the reduction of the visibility as the “continual change”. That is, in this case, the determining unit 106 determines that the first viewing environment and the second viewing environment are not identical. As illustrated in FIG. 12, specific examples of the “continual change by an action of a person” include opening and closing of a curtain, switching ON/OFF of lights, and the like. Furthermore, specific examples of the “change by a factor other than person” include irradiation of sunlight, and the like.

### 3-3. Flow of Processing

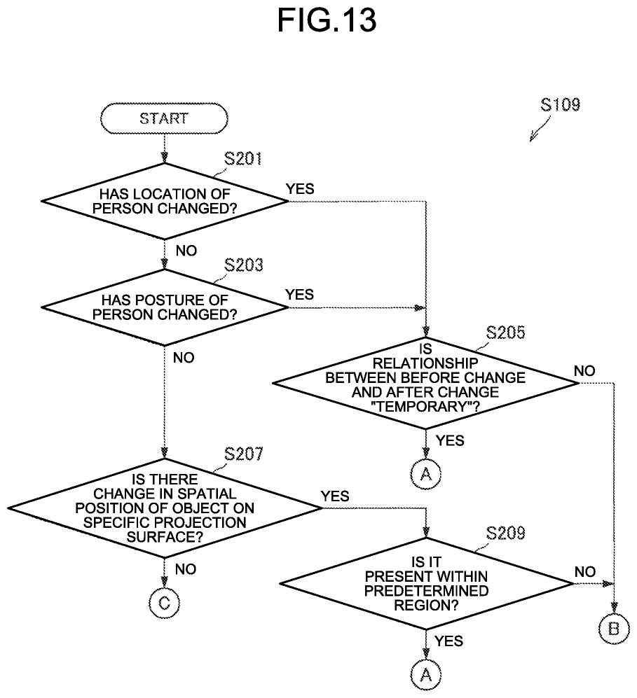

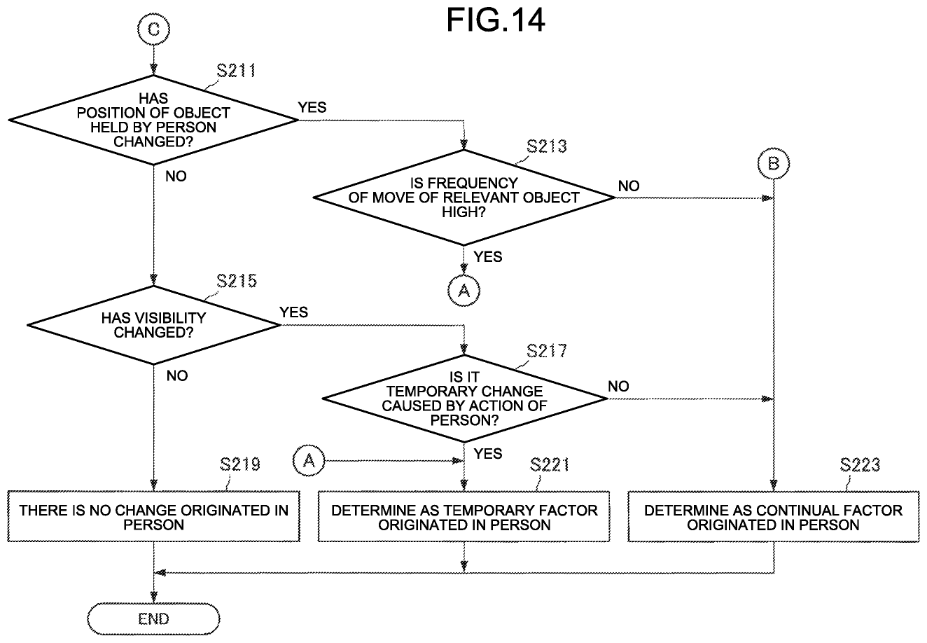

The configuration according to the second embodiment has been explained above. Next, a flow of processing according to the second embodiment will be explained. The flow of processing according to the second embodiment can differ only in processing at S109 (“analysis of a change factor of a display position of content”) in FIG. 7. In the following, a flow of detailed processing at S109 according to the second embodiment will be explained, referring to FIG. 13 and FIG. 14. Processing at S201 to S205 in FIG. 13 is same as that at S151 to S155 according to the first embodiment in FIG. 8.

At S203, when it is recognized that a posture of the user has not changed (S203: NO), the determining unit 106 determines whether it is recognized that at least one object positioned on a specific projection surface (for example, a projection surface on which the content are being projected) in the room 4 based on a sensing result by one or more units of the input unit 200 (S207) When it is recognized that at least one object has moved by a user (S207: YES), the determining unit 106 determines whether the position after the move of the object is within a predetermined region corresponding to the object (S209). When the position of the object after the move is within the predetermined region (S209: YES), the determining unit 106 performs processing of S221 described later. On the other hand, when the position of the object after the move is out of the predetermined region (S209: NO), the determining unit 106 performs processing of S223 described later.

A flow of processing when any object on the projection surface is not moved by a user at S207 (S207: NO) will be explained, referring to FIG. 14. As illustrated in FIG. 14, in this case, first, the determining unit 106 determines whether it is recognized that the user holds some kind of object, and a position of the object has changed (S211). When it is recognized that the position of the object held by the user has changed (S211: YES), the determining unit 106 determines whether the object is an object, frequency of move of which is equal to or higher than a predetermined threshold (S213). When it is determined that the object is an object, the frequency of move of which is equal to or higher than the predetermined threshold (S213: YES), the determining unit 106 performs processing of S221 described later. On the other hand, when it is determined that the object is an object, the frequency of move of which is lower than the predetermined threshold (S213: NO), the determining unit 106 performs processing of S223 described later.

On the other hand, when the user does not hold any object, or when it is recognized that a position of an object held by the user has not changed (S211: NO), the determining unit 106 next determines whether the visibility of the room 4 has changed by an amount equal to or larger than a predetermined threshold from that in the first timing (S215). When it is determined that a change amount of the visibility of the room 4 is smaller than the predetermined threshold (S215: NO), the determining unit 106 determines that a factor of a change of an optimal display position of the content determined at S107 is not a factor originated in person (S219).

On the other hand, when it is determined that the visibility of the room 4 has change by an amount equal to or larger than the predetermined threshold (S215: NO), the determining unit 106 next determines whether the change of the visibility is a temporary change caused by an action of a person (S217). When it is determined that the change of the visibility a temporary change caused by a person (S217: YES), the determining unit 106 determines that the factor of the change of the optimal position of the content determined at S107 is a “temporary factor originated in person” (S221). On the other hand, when it is determined that the change of the visibility is not a temporary change caused by an action of a person (S217: NO), the determining unit 106 determines that the factor of the change of the optical position of the content determined at S107 is a “continual factor originated in person” (S223).

### 3-4. Effect

As explained above, according to the second embodiment, output settings of the content by the output unit 202 after the second timing can be appropriately change, adaptively to a move of an object by a user, or a change of a state of the first place (change of environment) in a period between the first timing and the second timing. For example, even when either object on the projection surface on which the content are being projected is moved by a user, whether to change a projection position or a projection size of the content can be changed appropriately according to an attribute of the object and an amount of move of the object.

### 4. Third Embodiment

The second embodiment has been explained above. Next, a third embodiment according to the present disclosure will be explained. As described later, according to the third embodiment, when it is decided to change output settings of a content being output, if a user does not wish the change, execution of the change can be cancelled based on an instruction of the user.

### 4-1. Configuration

Next, a configuration according to the third embodiment will be explained. Respective components included in the information processing device 10 according to the third embodiment are similar to the examples illustrated in FIG. 3. In the following, only components having a different function from the second embodiment will be explained, and explanation of the same component will be omitted.

### 4-1-1. Input Unit 200

The input unit 200 according to the third embodiment can acquire, when the output control unit 108 has decided to change output settings for content, rejection information indicating that a user rejects the change of output settings for the content, or acceptance information indicating that the user accepts the change of output settings for the content.

### 4-1-1-1. Touch

An input method of the rejection information and/or the acceptance information may be, for example, direct touch by a user with respect to the content. As one example, when a pressing of the content before the change of output settings is detected, or when knocking on a surface (the projection surface by the projecting unit 202 or the like) on which the content before the change are being displayed is detected, the input unit 200 may acquire these detection results as the rejection information. Alternatively, when throwing of the content before the change is detected, or the like, the input unit 200 may acquire this detection result as the acceptance information.

### 4-1-1-2. Gesture

Alternatively, the input method of the rejection information and/or the acceptance information may be a predetermined gesture performed by a user with respect to the content. For example, when such a gesture of holding made with respect to the content before the change is detected or the like, the input unit 200 may acquire these gesture as the rejection information. Alternatively, when such a gesture of sweeping away made with respect to the content before the change is detected or the like, the input unit 200 may acquire this detection result as the acceptance information.

### 4-1-1-3. Voice

Alternatively, the input method of the rejection information and/or the acceptance information may be a predetermined speech given by a user. For example, when it is detected that a predetermined negative word (for example, “wait!”, “don't change!”, “cancel!”, and the like) is spoken, the input unit 200 may acquire this detection result as the acceptance information. Moreover, when it is detected that a predetermined positive word (for example, “move!” and the like) is spoken, the input unit 200 may acquire this detection result as the acceptance information. When it is detected, for example, that a speech explicitly instructing a change of output settings of the content as “display on . . . !” or the like is given, the output control unit 108 may adopt output settings corresponding to this detection result (for example, instead of output settings determined right before that).

### 4-1-1-4. Behavior of Body

Alternatively, the input method of the rejection information and/or the acceptance information may be a predetermined behavior made by a user. For example, when shaking head while looking at the content after the change is detected, or when nodding while looking at the content before the change is detected, the input unit 200 may acquire these detection results as the rejection information. Moreover, when shaking head while looking at the content before the change is detected, or when nodding while looking at the content after the change is detected, the input unit 200 may acquire these detection results as the acceptance information.

### 4-1-1-5. Arrangement of Object

Alternatively, the input method of the rejection information and/or the acceptance information may be placing some kind of object at a position corresponding to the content by a user. For example, when placing a coffee cup on the content before the change is detected or the like, the input unit 200 may acquire these detection results as the rejection information.

### 4-1-2. Output Control Unit 108

### 4-1-2-1. Control Example 1

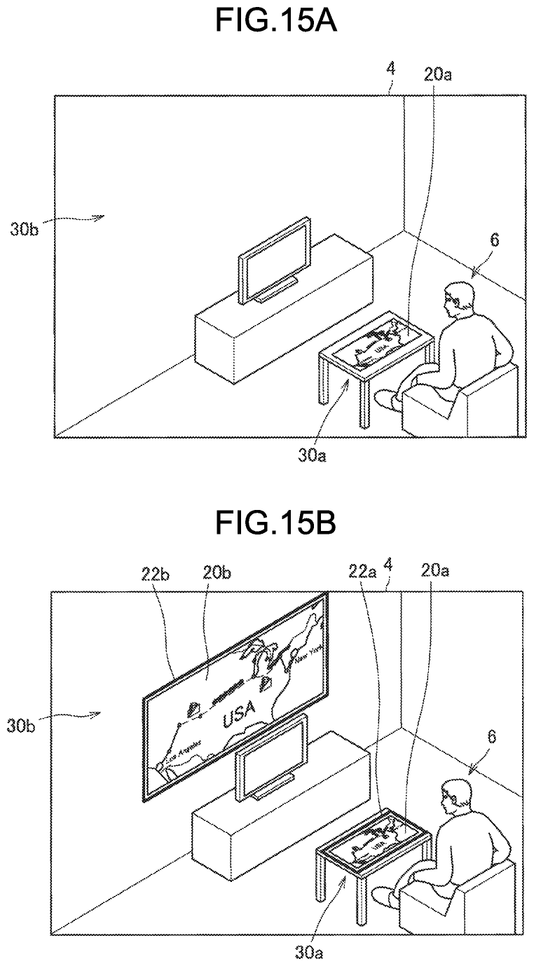

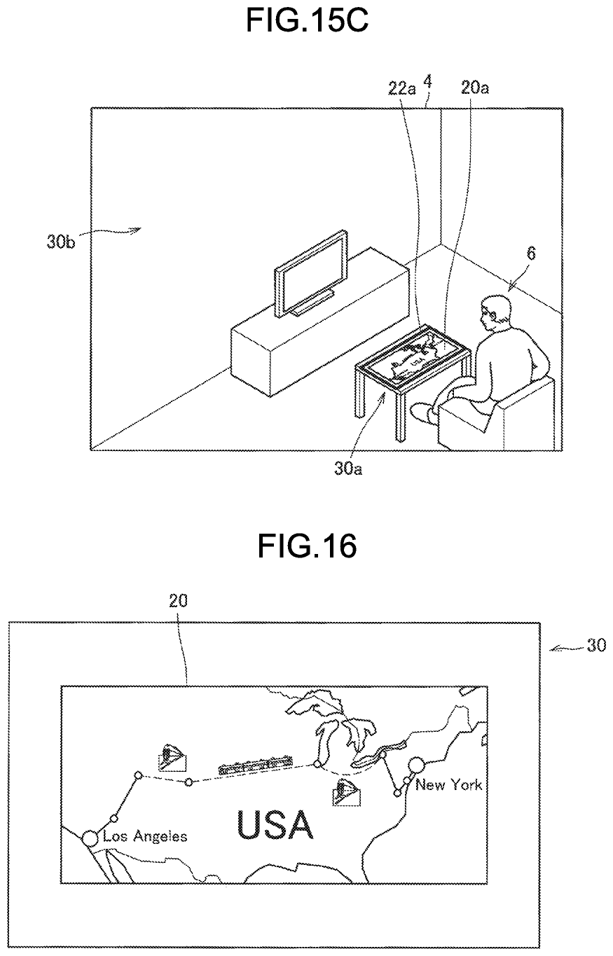

The output control unit 108 according to the third embodiment can change output settings of a content after the second timing based on a determination result by the determining unit 106 and an instruction input by a user. Functions described above will be explained in detail, referring to FIG. 15A to FIG. 15C. In the example illustrated in FIG. 15A, content 20a is projected on a top surface 30a (projection surface 30a) of a table by a projecting unit 202a in the room 4, and the user 6 is viewing the content 20a.

Suppose that a change of environment in the room 4 (for example, reduction of an area on which the content 20a can be projected within the projection surface 30a as a result of placing an obstacle on the projection surface 30a by a user) occurs after the timing illustrated in FIG. 15A. In this case, suppose that the determining unit 106 has determined that the optimal projection position of the content 20a is not the projection surface 30a but the wall surface 30b. Thereafter, as illustrated in FIG. 15B, the output control unit 108 causes the projecting unit 202a to project the content 20a on the projection surface 30a, and causes, for example, another projecting unit 202b to project content 20b same as the content 20a on the wall surface 30b. At this time, as illustrated in FIG. 15B, the output control unit 108 may cause respective frame 22a of the content 20a and frame 22b of the content 20b to be displayed (projected) in an emphasized manner. Thus, it is possible to show content before the change of the output settings (that is, the content 20a projected on the top plate 30a) and a destination after the change of the output position of the content 20a (that is, the wall surface 30b) to the user 6 in an emphasized manner.

Thereafter, suppose that the user desires the content 20 to be kept displayed on the top plate 30a of the table rather than on the wall surface 30b, and the user 6 performs a predetermined input (for example, touching the top plate 30a of the table, or the like) indicating the desire. In this case, as illustrated in FIG. 15C, the output control unit 108 ends projection of the content 20a only. That is, the projection state of the content 20 returns to the state illustrated in FIG. 15A.

### Supplement

Suppose that the determining unit 106 determines that the optimal projection position of the content 20 is not the wall surface 30b, but some kind of an image display device, such as a television receiver, after the timing illustrated in FIG. 15A. In this case, the output control unit 108 can cause the image display device to display the content 20b.

### 4-1-2-2. Control Example 2: Display Control Before Change

Alternatively, when the determining unit 106 determines that the first viewing environment and the second viewing environment are not identical, the output control unit 108 can change output settings of a content after the second timing, based on a determination result by the determining unit 106, and whether the rejection information is acquired by the input unit 200. In this case, for example, the output control unit 108 first causes the output unit 202 to output information indicating an output position after the change for the content within a predetermined limited time after the second timing. The output control unit 108 then (finally) changes the output settings of the content after the predetermined limited time, based on whether the rejection information of the user is acquired by the input unit 200 within the predetermined limited time.

The function described above will be explained in more detail, referring to FIG. 16 to FIG. 18. In the example illustrated in FIG. 16, the content 20 is projected on the projection surface 30 in the room 4 by the projecting unit 202.

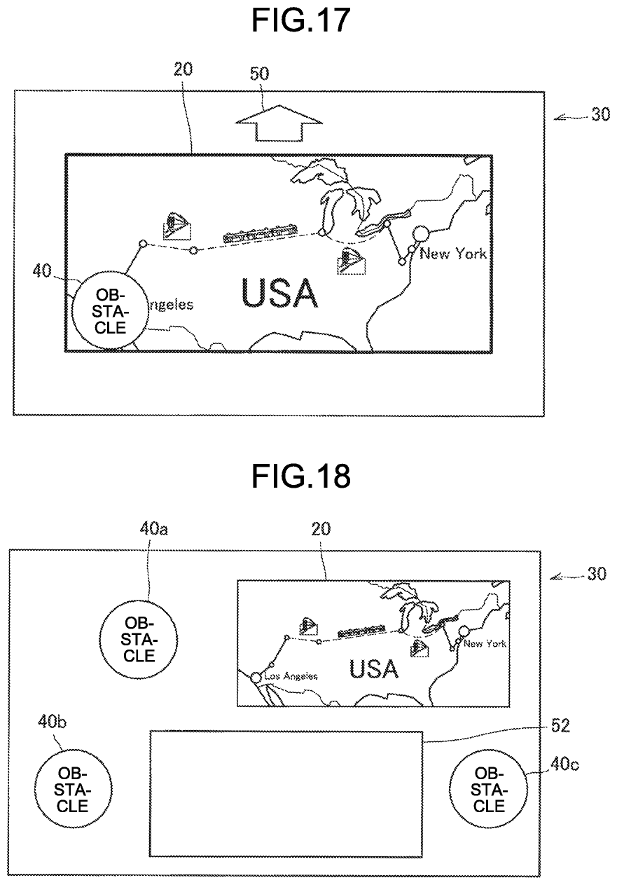

Suppose that the user has placed the obstacle 40 in a projection region of the content 20 in the projection surface 30 after the timing illustrated in FIG. 16. In this case, suppose that the output control unit 108 has decided to change the projection position of the content 20 to an upward direction illustrated in FIG. 16, so that the content 20 do not overlap the obstacle 40. In this case, as illustrated in FIG. 17, the output control unit 108 can cause the output unit 202 to further project with an effect (brightening or the like) on an outline of the content 20 for the predetermined limited time after the second timing, while maintaining the projection position of the content 20. Thus, it is possible to notify the user that the projection position of the content 20 is to be changed. Furthermore, as illustrated in FIG. 17, the output control unit 108 may cause the output unit 202 to further project an image 50 (for example, the image 50 of an arrow, or the like) indicating a direction of the projection position after the change of the content 20 on the projection surface 30 (as information indicating the output position after the change of the content 20).

When the output position after the change of the content 20 is positioned on the projection surface 30 same as the output position before the change, for example, as illustrated in FIG. 18, the output control unit 108 may cause the output unit 202 to further project a frame 52 indicating the output position after the change (as information indicating the output position after the change of the content 20) in the projection surface 30. In this case, the output control unit 108 can omit display of an effect additionally to the outline of the content 20, unlike the example in FIG. 17.

The length of the predetermined limited time is desirable to be determined to a length equal to or longer than time necessary for moving a driven projector (output unit 202) to project the content with respect to the output position after the change, and a change of posture. Thus, if the rejection information is acquired, the driven projector can project the content at the output position before the change again swiftly.

### 4-1-2-3. Control Example 3: Acceptance of Cancellation After Change

Alternatively, when the determining unit 106 determines that the first viewing environment and the second viewing environment are not identical, the output control unit 108 may first cause the output unit 202 to output a predetermined transition image at the determined display position of the content after the change for the predetermined limited time. The transition image can differ in a display mode from the content, and can be an image corresponding to the content. The output control unit 108 may change (finally) output settings of the content after the predetermined limited time based on whether the rejection information of the user is acquired within the predetermined limited time.

For example, when the rejection information of the user is acquired within the predetermined limited time, the output control unit 108 can turn back the output settings of the content thereafter, to the output settings before the change. Moreover, when the rejection information of the user is not acquired within the predetermined limited time, the output control unit 108 can set the output settings of the content after the predetermined limited time to the output settings determined in the second timing or right after that.

### Example 1 of Transition Image

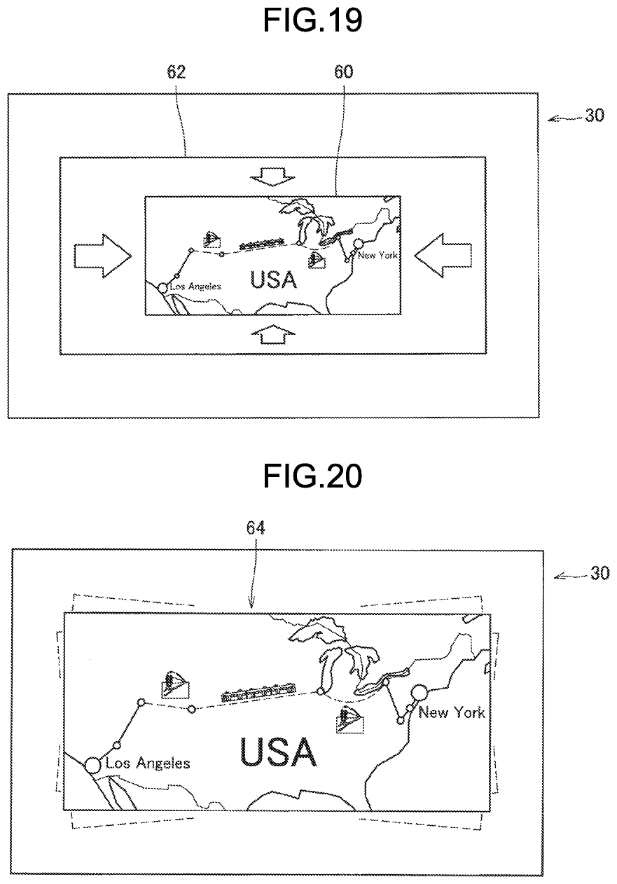

The above function will be explained in more detail, referring to FIG. 19 to FIG. 23. For example, when it is decided to reduce a display size of the content, as illustrated in FIG. 19, first, the output control unit 108 may cause the output unit 202 to output content 60 after a change, and a frame 62 indicating a display size before the change of the content 60 as the transition image on the projection surface 30 corresponding to the output position after the change. The output control unit 108 may reduce the size of the frame 62 gradually to the display size of the content 60 after the change within the predetermined limited time. As described above, when the rejection information of the user is acquired within the predetermined limited time, the output control unit 108 can turn back the output settings of the content thereafter, to the output settings before the change.

### Example 2 of Transition image

Alternatively, as illustrated in FIG. 20, the output control unit 108 may cause the output unit 202 to output an image same as the content after the change of the output settings as a transition image 64 on the projection surface 30 corresponding to the output position after the change, and may change a display mode of the transition image 64 successively within the predetermined limited time. For example, the output control unit 108 may shake the image consecutively, may change the sizes of the transition image successively, or may change the projection position of the transition image 64 successively on the projection surface 30 within the predetermined limited time. When the rejection information of the user is acquired within the predetermined limited time, the output control unit 108 can turn back the output settings of the content thereafter, to the output settings before the change.

### Example 3 of Transition Image

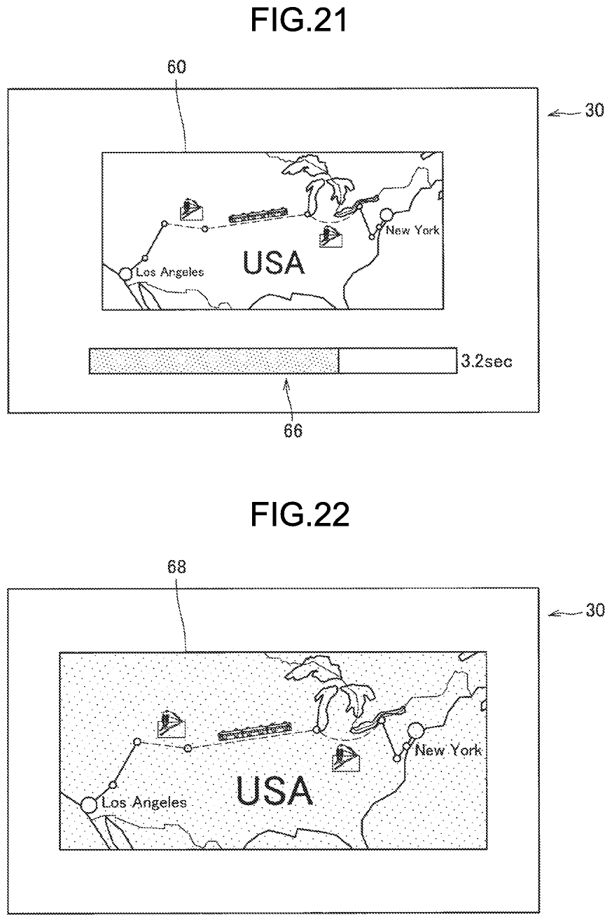

Alternatively, as illustrated in FIG. 21, the output control unit 108 may cause the output unit 202 to project the content after the change of the output settings and an indicator 66 that indicates elapsed time out of the predetermined limited time as the transition image on the projection surface 30 corresponding to the output position after the change. For example, as illustrated in FIG. 21, the output control unit 108 may cause the output unit 202 to project the indicator 66 near the content 60 after the change of the output settings. The output control unit 108 may gradually change the display mode of the indicator 66 as time elapses. As illustrated in FIG. 21, the indicator 66 may include a gauge that indicates elapsed time out of the predetermined limited time, or may include a character string that indicates remaining time (or elapsed time) out of the predetermined limited time.

According to the display example described above, a user can be aware of a length of remaining time in which output settings of the content can be turn back to the original. When the rejection information of the user is acquired within the predetermined limited time as described above, the output control unit 108 can turn back the output settings of the content thereafter, to the output settings before the change.

### Example 4 of Transition Image

Alternatively, as illustrated in FIG. 22, the output control unit 108 may cause the output unit 202 to output an image that only differs in a display mode (for example, a color tone, an a value, a degree of brilliancy, or a degree of blurriness, and the like) from the content after the change of the output settings as a transition image 68 within the predetermined limited time. For example, the output control unit 108 may change the display mode of the transition image 68 successively, for example, by fading in the transition image 68 within the predetermined limited time, or the like. When the rejection information of the user is acquired within the predetermined limited time as described above, the output control unit 108 can turn back the output settings of the content thereafter, to the output settings before the change.

### First Modification

It is also assumed that there is a case in which it is defined in advance that a part of region out of the predetermined transition image cannot be projected with respect to a projection surface including a display position of the content after the change (for example, when a part of region lies off the projection surface, or when the part of region cannot be displayed on the projection surface because a moving range of the driven projector (the output unit 202) is limited, or the like). In such a case, the output control unit 108 may cause, for example, another display device that is carried by a user, to output only the region that cannot be projected out of the entire part of the predetermined transition image. Alternatively, the output control unit 108 may change the shape or the size of the predetermined transition image such that the entire part of the predetermined transition image can be displayed on the relevant projection surface. Alternatively, the output control unit 108 may cause the output unit 202 capable of outputting sound to output a sound (for example, TTS, or the like) to inform about the image in the region that cannot be projected out of the entire part of the predetermined transition image.

### Second Modification

It is also assumed that there is a case in which when searching for a new candidate for a projection position of the content (that is, the output position after the change described above), an appropriate candidate position cannot be searched because search cannot be performed highly accurately. In such a case, the predetermined limited time described above may be set to be longer than usual. This increases the possibility that a user notices the transition image (animation), for example, as illustrated in FIG. 19 to FIG. 22. Moreover, time in which the user can determined whether to cancel the output settings after the change can become longer.

### Third Modification

As another modification, when the number of users present in the house 2 (or the number of users that are viewing content being output) is equal to or larger than a predetermined threshold, the output control unit 108 may switch to the output settings of the content to the output settings after the change directly, without performing an output control (Control Example 2) of information that indicates an output position after the change of the content, and/or a display control (Control Example 3) of the predetermined transition image described above. The output control unit 108 may perform these controls (“Control Example 2” and/or “Control Example 3”) for urgent information exceptionally.

### 4-2. Flow of Processing

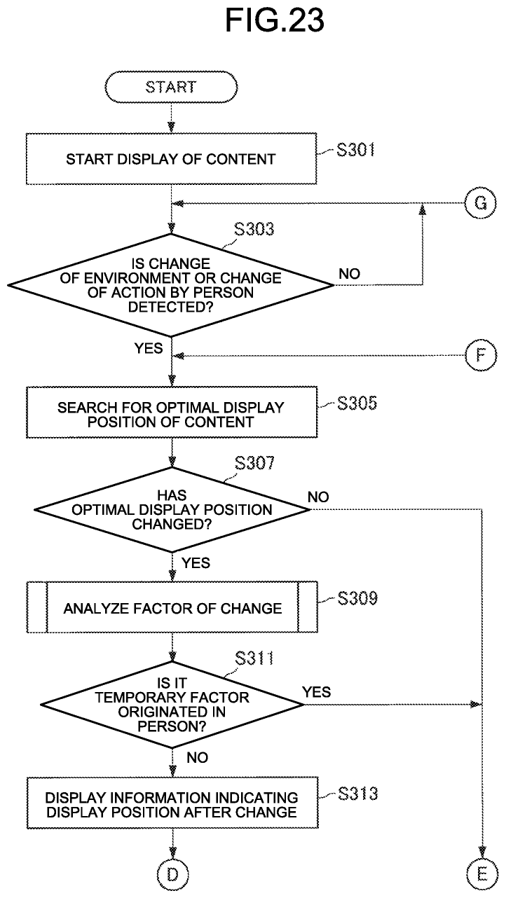

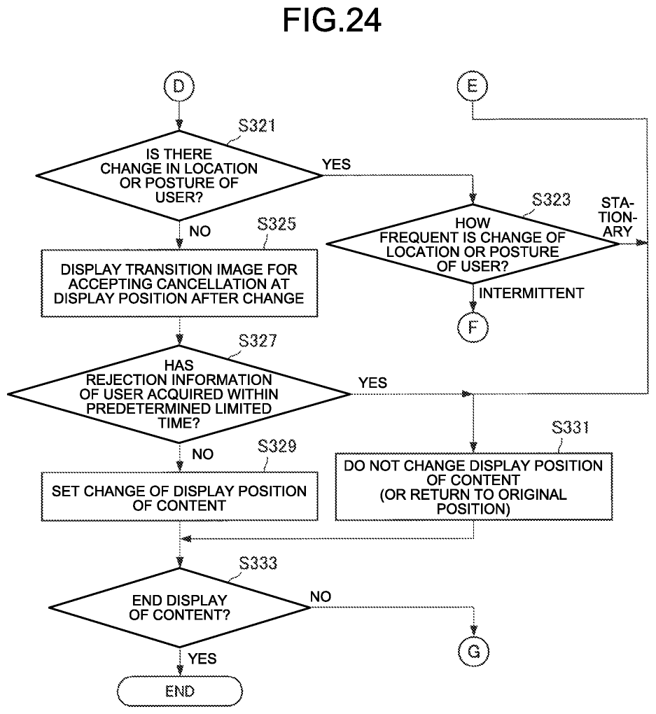

The configuration according to the third embodiment has been explained above. Next, a flow of processing according to the third embodiment will be explained, referring to FIG. 23 and FIG. 24.

FIG. 23 is a flowchart illustrating a part of one example of an overall flow of processing according to the third embodiment. S301 to S311 illustrated in FIG. 23 can be same as S101 to S111 according to the first embodiment illustrated in FIG. 7.

As illustrated in FIG. 23, when a factor determined at S309 is not the “temporary factor originated in person” (S311: NO), the output control unit 108 causes the output unit 202 to display information (image or the like) indicating a display position searched at latest S305 (S313).

A flow of processing at S313 and later will be explained, referring to FIG. 24. As illustrated in FIG. 24, after S313, the determining unit 106 determines whether a change of location or a change of posture of the user is detected after S313 based on a recognition result by the action recognizing unit 102 (S321). When a change of location or a change of posture of the user is detected (S321: YES), the determining unit 106 determines the frequency of change of location or posture of the user based on a recognition result by the action recognizing unit 102 (S323). When it is determined that the frequency of change of location or posture of the user is “stationary”, the output control unit 108 performs processing of S331 described later. As a modification, when it is determined that the user moves constantly at S323, the output control unit 108 may stop output of the content by the output unit 202 that has been outputting the content, and may cause another device (for example, a wearable device worn by the user, or a display device carried by the user (smartphone, or the like) and the like) to output the content. Alternatively, in this case, the output control unit 108 may stop output of the content by the output unit 202 that has been outputting the content, and may output information corresponding to the content by using another output method (for example, outputting by sound instead of display), or the like).

On the other hand, when it is determined that the frequency of change of location or posture of the user is “intermittent”, the output control unit 108 repeats the processing at S305 and later again.

On the other hand, when a change of location or a change of posture of the user is not detected (S321: NO), the output control unit 108 causes the output unit 202 to project the predetermined transition image for accepting cancellation at a display position after the change of the content determined at latest S307 (S325).

Thereafter, within the predetermined limited time from the timing of S325, the output control unit 108 determines whether the rejection information of the user is acquired by the input unit 200 (S327). When the rejection information of the user is not acquired by the input unit 200 within the predetermined limited time (S327: NO), the output control unit 108 changes the display position of the content to a display position searched at latest S305 (S329). Thereafter, the output control unit 108 performs processing of S333. The processing at S333 is generally the same as S117 illustrated in FIG. 7.

On the other hand, when the rejection information of the user is acquired by the input unit 200 within the predetermined limited time (S327: YES), the output control unit 108 decides not to change the display position of the content, or to return to the display position right before (S331). Thereafter, the output control unit 108 performs processing of S333 described above.

### 4-3. Effect

As explained above, according to the third embodiment, when change of output settings of content being output is decided, if a user does not desire the change, the it is possible to cancel execution of the change based on an instruction of the user.

### 5. Hardware Configuration

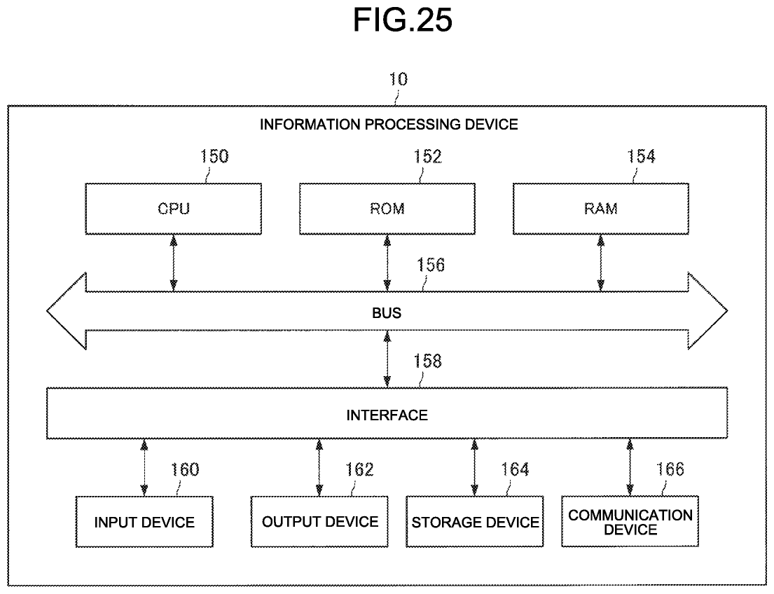

The third embodiment has been explained above. Next, a hardware configuration example of the information processing device 10 according to the respective embodiments will be explained, referring to FIG. 25. As illustrated in FIG. 25, the information processing device 10 includes a CPU 150, a read only memory (ROM) 152, a random access memory (RAM) 154, a bus 156, an interface 158, an input device 160, an output device 162, a storage device 164, and a communication device 166.

The CPU 150 functions as an arithmetic processing device and a control device, and control overall operation of the information processing device 10 in accordance with various kinds of programs. Moreover, the CPU 150 implements functions of the control unit 100 in the information processing device 10. The CPU 150 is constituted of a processor, such as a microprocessor.

The ROM 152 stores control data, such as a program used by the CPU 150 and arithmetic parameters, and the like.

The RAM 154 temporarily stores, for example, a program executed by the CPU 150, data being used, and the like.

The bus 156 is constituted of a CPU bus. This bus 156 connects the CPU 150, the ROM 152, and the RAM 154 with one another.

The interface 158 connects the input device 160, the output device 162, the storage device 164, and the communication device 166 with the bus 156.

The input device 160 is constituted of an input means for a user to input information, such as a touch panel, a button, a switch, a lever, and a microphone, and an input control circuit that generates an input signal based on an input by a user, to output to the CPU 150, and the like.

The output device 162 includes a display, such as an LCD and an OLED, or a display device, such as a projector. Moreover, the output device 162 includes a sound output device, such as a speaker.

The storage device 164 is a device for data storage that functions as the storage unit 122. The storage device 164 includes, for example, a storage medium, a recording medium that records data in the storage medium, a reader device that reads data from the storage medium, a deleting device that deletes data stored in the storage medium, or the like.

The communication device 166 is a communication interface that is constituted of a communication device (for example, a network card, or the like) to connect to a predetermined communication network described above, and the like. Moreover, the communication device 166 may be a wireless-LAN compatible communication device, a long term evolution (LTE) compatible communication device, or a wired communication device that performs communication by wired communication. This communication device 166 functions as the communication unit 120.

### 6. Modification

Exemplary embodiments of the present disclosure have been explained in detail above, referring to the accompanying drawings, but the present disclosure is not limited to those examples. It is apparent that those who have ordinary knowledge in a field of technology to which the present disclosure belongs can think of various modifications and correction examples within a range of technical idea described in a scope of the patent claims , and it is naturally understood that these also belong to a technical scope of the present disclosure.

For example, respective steps in the flow of processing according to the respective embodiments described above are not necessarily required to be processed in described order. For example, the respective steps may be processed, appropriately changing order. Moreover, the respective steps may be processed partially in parallel, or independently, instead of processed chronologically. Furthermore, some out of the described steps may be omitted, or another step may further be added.

Moreover, according to the respective embodiments described above, computer programs to make hardware, such as the CPU, the ROM, and the RAM, have functions equivalent to the respective components included in the information processing device 10 according to the respective embodiments described above can be provided. Moreover, a recording medium in which the computer programs are recorded can also be provided.

Furthermore, an effect described in the present application is only explanatory or exemplary, but not limited. That is, the technique according to the present disclosure can produce other effects obvious to those skilled in the art from the description of the present specification, together with the above effect, or in addition to the above effect.

Configurations as follows also belong to the technical scope of the present disclosure.

(1)

An information processing device comprising an output control unit that changes, based on whether it is determined that a first viewing environment of a content in first timing in which the content has been output and a second viewing environment of the content in second timing that is later than the first timing are identical based on information of a user that has been viewing the content in the first timing, output settings of the content by an output unit after the second timing.

(2)

The information processing device according to (1), further comprising

a first recognizing unit that recognizes an action of the user started after the first timing, wherein

the information of a user includes a recognition result of an action of the user obtained by the first recognizing unit in a period between the first timing and the second timing.

(3)

The information processing device according to (2), wherein

the information of a user indicates whether it has been recognized that the user has moved from a first place corresponding to the first viewing environment to a second place in a period between the first timing and the second timing by the first recognizing unit, and

the output control unit changes the output settings of the content after the second timing based on whether it is determined that the first viewing environment and the second viewing environment are identical further based on information indicating a relationship between the first place and the second place.

(4)

The information processing device according to (2) or (3), wherein

the information of a user indicates whether it is recognized that a posture of the user has been changed from a first posture in the first timing to a second posture in a period between the first timing and the second timing by the first recognizing unit, and

the output control unit changes the output settings of the content after the second timing based on whether it is determined that the first viewing environment and the second viewing environment are identical further based on information indicating a relationship between the first posture and the second posture.

(5)

The information processing device according to any one of (1) to (4), wherein

the information of a user includes a detection result on whether a predetermined object in a first place corresponding to the first viewing environment has been moved out of a predetermined region that corresponds to the predetermined object by a user in a period between the firs timing and the second timing.

(6)

The information processing device according to (5), wherein

the predetermined object is an object having a predetermined attribute.

(7)

The information processing device according to any one of (1) to (6), further comprising

a second recognizing unit that recognizes a change of a state of a first place corresponding to the first viewing environment, wherein

the output control unit changes the output settings of the content after the second timing based on whether it is determined that the first viewing environment and the second viewing environment are identical further based on a degree of change of a state of the first place recognized by the second recognizing unit in a period between the first timing and the second timing.

(8)

The information processing device according to any one of (3) to (7), wherein

the output settings of the content includes at least an output position of the content in real space, a display size of the content, a brightness of the content, a contrast of the content, and identification information of an output unit that outputs the content out of one or more units of output unit.

(9)

The information processing device according to (8), wherein

when it is determined that the first viewing environment and the second viewing environment are not identical, the output control unit changes the output settings of the content after the second timing according to the second viewing environment.

(10)

The information processing device according to (9), wherein

when it is determined that the first viewing environment and the second viewing environment are identical, the output control unit does not change the output settings of the content.

The information processing device according to (9) or (10), wherein

the output settings of the content includes an output position of the content in real space, and

when it is determined that the first viewing environment and the second viewing environment are not identical, the output control unit determines an output position of the content after the second timing to a predetermined position in the second place.

(12)

The information processing device according to (11), wherein

the first place and the second place are located in predetermine facility,

the output unit is a projecting unit that is configured to be able to change at least one of a position and an orientation based on a control by the output control unit,

the content includes an image, and

when it is determined that the first viewing environment and the second viewing environment are not identical, the output control unit changes a projection position of the content from a projection position of the content in the first place in the first timing to a predetermined position in the second place successively.

(13)

The information processing device according to any one of (9) to (12), further comprising

an acquiring unit that acquires rejection information indicating that a user rejects a change of the output settings of the content, wherein

when it is determined that the first viewing environment and the second viewing environment are not identical, the output control unit changes the output settings of the content after the second timing further based on whether the rejection information is acquired by the acquiring unit.

(14)

The information processing device according to (13), wherein

the output settings of the content includes an output position of the content in real space,

when it is determined that the first viewing environment and the second viewing environment are not identical, the output control unit causes the output unit to output information that indicates an output position of the content after the change within predetermined time after the second timing, and

changes the output settings of the content after the predetermined time based on whether the rejection information of the user is acquired within the predetermined time.

(15)

The information processing device according to (14), wherein

the content includes an image,

the information indicating an output position of the content after the change is different in a display mode from the content, and is a predetermined image corresponding to the content,

when it is determined that the first viewing environment and the second viewing environment are not identical, the output control unit causes the output unit to output the predetermined image at the output position of the content after the change within the predetermined time.

(16)

The information processing device according to any one of (9) to (15), wherein

the first place and the second place are located in predetermined facility.

(17)

The information processing device according to (16), wherein

the output unit is a projecting unit that is configured to be able to change at least one of a position and an orientation based on a control by the output control unit.

(18)

The information processing device according to (16) or (17), further comprising

a determining unit that determines whether the first viewing environment and the second viewing environment are identical based on the information of a user.

(19)

An information processing method comprising

changing output settings of a content by an output unit after a second timing based on whether it is determined that a first viewing environment of the content in a first timing in which the content has been output and a second viewing environment of the content in a second timing that is later than the first timing are identical based on information of a user that has been viewing the content in the first timing, by a processor.

(20)

A computer-readable recording medium that stores a program to make a computer function as

an output control unit that changes, based on whether it is determined that a first viewing environment of a content in first timing in which the content has been output and a second viewing environment of the content in second timing that is later than the first timing are identical based on information of a user that has been viewing the content in the first timing, output settings of the content by an output unit after the second timing.

### REFERENCE SIGNS LIST

2 HOUSE

4 ROOM

10 INFORMATION PROCESSING DEVICE

100 CONTROL UNIT

102 ACTION RECOGNIZING UNIT

104 ENVIRONMENT RECOGNIZING UNIT

106 DETERMINING UNIT

108 OUTPUT CONTROL UNIT

120 COMMUNICATION UNIT

122 STORAGE UNIT

200 INPUT UNIT

202 OUTPUT UNIT

1. An information processing device comprising
an output control unit that changes, based on whether it is determined that a first viewing environment of a content in first timing in which the content has been output and a second viewing environment of the content in second timing that is later than the first timing are identical based on information of a user that has been viewing the content in the first timing, output settings of the content by an output unit after the second timing.

2. The information processing device according to claim 1, further comprising
a first recognizing unit that recognizes an action of the user started after the first timing, wherein
the information of a user includes a recognition result of an action of the user obtained by the first recognizing unit in a period between the first timing and the second timing.

3. The information processing device according to claim 2, wherein
the information of a user indicates whether it has been recognized that the user has moved from a first place corresponding to the first viewing environment to a second place in a period between the first timing and the second timing by the first recognizing unit, and
the output control unit changes the output settings of the content after the second timing based on whether it is determined that the first viewing environment and the second viewing environment are identical further based on information indicating a relationship between the first place and the second place.

4. The information processing device according to claim 2, wherein
the information of a user indicates whether it is recognized that a posture of the user has been changed from a first posture in the first timing to a second posture in a period between the first timing and the second timing by the first recognizing unit, and
the output control unit changes the output settings of the content after the second timing based on whether it is determined that the first viewing environment and the second viewing environment are identical further based on information indicating a relationship between the first posture and the second posture.

5. The information processing device according to claim 1, wherein
the information of a user includes a detection result on whether a predetermined object in a first place corresponding to the first viewing environment has been moved out of a predetermined region that corresponds to the predetermined object by a user in a period between the firs timing and the second timing.

6. The information processing device according to claim 5, wherein
the predetermined object is an object having a predetermined attribute.

7. The information processing device according to claim 1, further comprising
a second recognizing unit that recognizes a change of a state of a first place corresponding to the first viewing environment, wherein
the output control unit changes the output settings of the content after the second timing based on whether it is determined that the first viewing environment and the second viewing environment are identical further based on a degree of change of a state of the first place recognized by the second recognizing unit in a period between the first timing and the second timing.

8. The information processing device according to claim 3, wherein
the output settings of the content includes at least an output position of the content in real space, a display size of the content, a brightness of the content, a contrast of the content, and identification information of an output unit that outputs the content out of one or more units of output unit.

9. The information processing device according to claim 8, wherein
when it is determined that the first viewing environment and the second viewing environment are not identical, the output control unit changes the output settings of the content after the second timing according to the second viewing environment.

10. The information processing device according to claim 9, wherein
when it is determined that the first viewing environment and the second viewing environment are identical, the output control unit does not change the output settings of the content.

11. The information processing device according to claim 9, wherein
the output settings of the content includes an output position of the content in real space, and
when it is determined that the first viewing environment and the second viewing environment are not identical, the output control unit determines an output position of the content after the second timing to a predetermined position in the second place.

12. The information processing device according to claim 11, wherein
the first place and the second place are located in predetermine facility,
the output unit is a projecting unit that is configured to be able to change at least one of a position and an orientation based on a control by the output control unit,
the content includes an image, and
when it is determined that the first viewing environment and the second viewing environment are not identical, the output control unit changes a projection position of the content from a projection position of the content in the first place in the first timing to a predetermined position in the second place successively.

13. The information processing device according to claim 9, further comprising
an acquiring unit that acquires rejection information indicating that a user rejects a change of the output settings of the content, wherein
when it is determined that the first viewing environment and the second viewing environment are not identical, the output control unit changes the output settings of the content after the second timing further based on whether the rejection information is acquired by the acquiring unit.

14. The information processing device according to claim 13, wherein
the output settings of the content includes an output position of the content in real space,
when it is determined that the first viewing environment and the second viewing environment are not identical, the output control unit causes the output unit to output information that indicates an output position of the content after the change within predetermined time after the second timing, and
changes the output settings of the content after the predetermined time based on whether the rejection information of the user is acquired within the predetermined time.

15. The information processing device according to claim 14, wherein
the content includes an image,
the information indicating an output position of the content after the change is different in a display mode from the content, and is a predetermined image corresponding to the content,
when it is determined that the first viewing environment and the second viewing environment are not identical, the output control unit causes the output unit to output the predetermined image at the output position of the content after the change within the predetermined time.

16. The information processing device according to claim 9, wherein
the first place and the second place are located in predetermined facility.

17. The information processing device according to claim 16, wherein
the output unit is a projecting unit that is configured to be able to change at least one of a position and an orientation based on a control by the output control unit.

18. The information processing device according to claim 16, further comprising
a determining unit that determines whether the first viewing environment and the second viewing environment are identical based on the information of a user.

19. An information processing method comprising
changing output settings of a content by an output unit after a second timing based on whether it is determined that a first viewing environment of the content in a first timing in which the content has been output and a second viewing environment of the content in a second timing that is later than the first timing are identical based on information of a user that has been viewing the content in the first timing, by a processor.

20. A computer-readable recording medium that stores a program to make a computer function as
an output control unit that changes, based on whether it is determined that a first viewing environment of a content in first timing in which the content has been output and a second viewing environment of the content in second timing that is later than the first timing are identical based on information of a user that has been viewing the content in the first timing, output settings of the content by an output unit after the second timing.
